(19) United States
(12) Patent Application Publication
(10) Pub. No.: US 2023/0196353 A1
(43) Pub. Date: Jun. 22, 2023

(54) Systems and Methods for Robust Personalization with Applications to NFT Evolution and Generation of Art Remixes with Personalization

(71) Applicant: Artema Labs, Inc, Los Angeles, CA (US)

(72) Inventors: Bjorn Markus Jakobsson, Portola Valley, CA (US); Perry R. Cook, Jacksonville, OR (US); Ajay Kapur, Valencia, CA (US); Rebecca Anne Fiebrink, London (GB)

(73) Assignee: Artema Labs, Inc, Los Angeles, CA (US)

(21) Appl. No.: 18/067,579

(22) Filed: Dec. 16, 2022

Related U.S. Application Data
(60) Provisional application No. 63/293,809, filed on Dec. 26, 2021.
(60) Provisional application No. 63/291,411, filed on Dec. 19, 2021.

(51) Int. Cl. G06Q 20/38; G06Q 20/40

(52) U.S. Cl. CPC G06Q 20/389; G06Q 20/401; G06Q 20/3829

(57) ABSTRACT

Non-fungible token (NFT) platforms in accordance with various embodiments of the invention are described. In an embodiment of the NFT platform includes a first personal profile record associated with a first entity and a second personal profile record associated with a second entity; accessing the first personal profile record; accessing the second personal profile record; determining that the first entity and the second entity are the same; determining that there is a conflict associated between a first element associated with the first personal profile record and a second element associated with the second personal profile record, where the determination is based at least in part on a first policy; determine an action based on the determination of conflict and at least in part on a second policy; and initiate the determined action.

### CROSS-REFERENCE TO RELATED APPLICATION

This application claims benefit of and priority under 35 U.S.C. 119(e) to U.S. Provisional Patent Application No. 63/291,411 entitled “Robust Personalization with Applications to NFT Evolution” by Jakobsson, filed Dec. 19, 2021, and to U.S. Provisional Patent Application No. 63/293,809 entitled “Art Remixes with Personalization”, by Cook et al., filed Dec. 26, 2021, the disclosures of which are hereby incorporated by reference in their entirety for all purposes.

### FIELD OF THE INVENTION

This invention relates to tokens including non-fungible tokens (NFTs) in distributed and tokenized environments. In particular, to environments that provide protection against token-based malicious scripts.

### BACKGROUND

The emergence of Non-Fungible Token (NFT) marketplaces has allowed content creators (e.g., artists, musicians, among others) to reach buyers. Furthermore, the trading of NFTs is becoming increasingly common. In particular, an NFT may be used for assigning a digital representation of ownership for digital items, such as images, but also other physical items. As NFTs become increasingly complex, it can be increasingly difficult to protect against potential abuses, including protecting against malicious scripts.

Likewise, traditional beliefs, such as horoscopes, typically combine very poorly with concurrent technologies, such as smart contracts and cryptography. It may be desirable to enable such combinations, for example, by facilitating token evolution based on birth location and zodiac signs. However, since token evolution can have monetary benefits, abuse may likely to take place unless carefully addressed. These types of abuses, which may entail a rapid circling through possible birth places and zodiac signs in order to trigger evolution, have not been addressed by existing technology. This may not be due to the unusual construct, but due to the absence of an entire class of countermeasures that can be applied to a range of related problems. These problems can, generally speaking, be described as involving a brute-force triggering attack against a Blackbox algorithm, where an attacker enumerates and evaluates possible inputs to a Blackbox algorithm in order to identify a beneficial configuration. Here, the Blackbox may correspond to an evolution algorithm, which may be secret. However, it may also correspond to a filtering mechanism, which can have wide-ranging applications within applied computer science.

The relationship between artists and fans can be made difficult by numerous factors. The desired level of scarcity of an artwork may elevate the sale price, but disappoint fans that are unable to enjoy the work. Such scarcity drives artists to create new art to sell, which can involve significant work. The burdens of keeping up with demand can overtax artists, and restrict their ability to innovate and create varied artworks. To reduce such demands, artists often sell many copies of a same piece, which decreases value and compromises the sense of scarcity. The artist can number and sign the series, but all of the “prints” are identical in every other way. Art sold as non-fungible tokens (NFTs) enables artists to create editions, or multiple “copies” of an art work, but pricing needs put pressure on the artist to limit the supply which in turn frustrates buyers that would like to obtain an entire artist's portfolio. Collectors wishing to collect a large portion or all of an artist's portfolio are prevented from comparing the works of an artist due to supply constraints and the collector can also miss out on creating fan communities around the series of unique works.

### SUMMARY OF THE INVENTION

Systems and methods for providing generating personal profile record NFTs in distributed and tokenized environments in accordance with various embodiments of the invention are described. One embodiment includes a non-fungible token (NFT) platform for processing tokens in a distributed computing environment, including: a network interface; memory; and at least one processor executing on at least one computing unit from several computing units in a distributed computing environment, where a processor is configured to: maintain a database of several personal profile records, where each personal profile record is associated with a particular entity and includes several data elements associated with different types of data for the particular entity; obtain a first personal profile record associated with a first entity; obtain a second personal profile record associated with a second entity; determine that the first entity and the second entity are a same entity; detect a conflict between a data element associated with the first personal profile record and a data element associated with the second personal profile record, where the data element associated with the first personal profile record and the data element associated with the second personal profile record include a same type of data and detecting a conflict includes analyzing a smart contract associated with at least one of the first personal profile record and the second personal profile record; initiate an action based on the smart contract associated with the at least one of the first personal profile record and the second personal profile record.

In a further embodiment, the first entity is an individual.

In a further embodiment, the first entity is a group of individuals.

In a further embodiment, the first entity is an enterprise.

In a further embodiment, the first personal profile record includes a digital signature that is verified using a public key associated with the first entity.

In a further embodiment, the first personal profile record includes a digital signature that is verified using a public key associated with a certification authority.

In a further embodiment, the smart contract associated with a first descriptor, the first descriptor comprised in the first personal profile record.

In a further embodiment, the conflict is determined based on a first value associated with the first descriptor.

In a further embodiment, data associated with the smart contract is stored in the first personal profile record.

In a further embodiment, data associated with the smart contract is public.

In a further embodiment, the action is at least one of allowing and disallowing an event taking place and generating a secure log entry.

In a further embodiment, the secure log entry includes encrypted information.

In a further embodiment, the secure log entry includes authenticated information.

In a further embodiment, the authenticated information is generated using a forward-secure authentication scheme.

In a further embodiment, the determined action includes generating a non-fungible token (NFT) based at least in part on the first personal profile record or the second personal profile record.

An embodiment includes a system for automatically generating at least two non-fungible tokens (NFTs) based on at least one content element, including: obtaining the at least one content; determining a first selector value; determining a second selector value that is distinct from the first selector value; generating a first content element from the at least one content element and the first selector value; generating a second content element from the at least one content element and the second selector value, where the second content element is distinct from the first content element; generating a first NFT associated with the first content element; and generating a second NFT associated with the second content element.

In a further embodiment, at least one content element is one or more still images.

In a further embodiment, at least one content element is one or more video media.

In a further embodiment, in at least one content element is one or more MIDI or other musical score files.

In a further embodiment, at least one content element is one or more music or audio recordings.

In a further embodiment, at least one content element is one or more text files.

In a further embodiment, the first selector value is computed as a cryptographic hash on at least one input value.

In a further embodiment, the first selector value is a counter.

In a further embodiment, the first content element is generated using an artificial intelligence process taking the first selector value as a seed.

In a further embodiment, the first selector value indicates at least one frame of a series of frames associated with the at least one content element.

In a further embodiment, the first selector value is used as an input to a pseudo-random generator used to make at least two selections of portions associated with the first content element.

In a further embodiment, the first NFT can evolve to become the second NFT.

In a further embodiment, the first selector value is used to emphasize a first aspect of the at least one content element, and the second selector value is used to emphasize a second aspect of the at least one content element.

In a further embodiment, the first aspect corresponds to a first audio source and the second aspect corresponds to a second audio source.

In a further embodiment, one or more content elements are user-contributed.

In a further embodiment, one or more content elements are extracted from information about or held by the user.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permission-less blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates a process for generation of an anchor for a user that includes several personal profile records in accordance with an embodiment of the invention.

FIG. 19 illustrates a personal profile record that includes several data elements for different types of data in accordance with an embodiment of the invention.

FIG. 20 illustrates a process for determining a conflict based on a series of events in accordance with an embodiment of the invention.

FIG. 21 illustrates a process for throttling actions based on a detection of a conflict in accordance with an embodiment of the invention.

FIG. 22 illustrates an NFT platform that generates remixes using source materials, seed data, and data in accordance with an embodiment of the invention.

FIG. 23 illustrates an NFT platform that generates remixes using musical source materials, seed data, and data in accordance with an embodiment of the invention.

FIG. 24 illustrates an NFT platform that generates remixes using textual and/or spoken word source materials, seed data, and data in accordance with an embodiment of the invention.

FIG. 25 illustrates an NFT platform that generates remixes using a set of source materials, such as images, video, music, other audio, and text source materials, seed data, and data in accordance with an embodiment of the invention.

FIG. 26 illustrates an NFT platform that generates new NFTs using several NFTs in accordance with an embodiment of the invention.

### DETAILED DESCRIPTION

Turning now to the drawings, systems and methods for implementing blockchain-based Non-Fungible Token (NFT) that can generate conditional tokens in accordance with various embodiments of the invention are illustrated. In several embodiments, a blockchain-based NFT security platform is provided that generates NFTs that enable content creators to issue, mint, and/or transfer NFTs that can include different data elements that can specify different access control settings, including permitted and/or restricted data that can be accessible by other NFTs. NFT platforms in accordance with many embodiments can generate personal profile records that can be associated with at least one person and/or entity. In many embodiments, different personal profile record NFTs can be analyzed to determine whether there is a conflict, and upon detecting a conflict, control the generation of new NFTs based on a throttling that can determine a time period during which new NFTs may not be generated. In many embodiments, a throttling can be determined based on a smart contracted associated with an NFT. In many embodiments, a conflict between personal profile records NFTs can be detected based on an analysis of data elements within each of the personal profile records. Certain embodiments can analyze time stamps associated with different personal profile records to detect conflicts. Upon detecting a conflict, many embodiments can specify a particular action that may be appropriate based on the type of conflict, including disabling the generation of new NFTs for a time period, among other actions.

In many embodiments, a personal profile record can be associated with an individual, a group of individuals, an enterprise, among other type of groups and/or entities. A personal profile record NFT can include a digital signature that can be verified using a public key associated with the personal profile record.

NFT platforms in accordance with many embodiments can include personal profile record NFTs that include several data elements, each data element associated with a particular type of data. In many embodiments, different data elements of a personal profile record NFT can be associated with a smart contract and/or policy that can specify settings for the particular data elements. Different data elements can have different privacy settings, including public, private, and/or limited access.

In many embodiments, based on a conflict detection, an action can include allowing an event taking place or disallowing an event taking place, generating a secure log entry, among other types of actions. A security log can include encrypted information, authenticated information. In certain embodiments, authenticated information can be generated using a forward-secure authentication scheme. In many embodiments, an action can include generating a non-fungible token (NFT) based on at least one personal profile record NFT.

NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFT platforms in accordance with many embodiments provide. NFT platforms can include different execution environments that facilitate the storage and usage of tokens, including digital wallets and/or digital wallet applications, digital rights management (DRM) systems that can include secure software and/or hardware, secure execution environments such as TrustZone among others that can provide security assurances using secure boot processes. NFT platforms in accordance with many embodiments can include software and/or hardware configurations that protect an execution environment against potential abuses.

NFT platforms in accordance with many embodiments can automatically create unique NFT art and creative works, where an NFT can be personalized to a user. NFT platforms in accordance with several embodiments can utilize automated processes for “Generative Rem ix”, whereby the system can create several different versions from a limited set of resources and/or from an idea and/or theme. NFT platforms in accordance with several embodiments can provide on-demand artworks that can provide benefits over prior techniques such as “numbered signed prints”, as each NFT can be unique, customized and/or personalized to a person (e.g., a person purchasing a work). In many embodiments, a set of generated NFT works may appear to be from a series and/or family, however each NFT can be unique and/or personalized for an individual person.

NFT platforms in accordance with several embodiments can automatically generate several different NFT artwork versions. NFT platforms in accordance with several embodiments can allow different types of personalization, whereby individual users can contribute to automatically generated/modified NFT artworks, providing an engaging experience and increasing potential for marketing. NFT platforms in accordance with many embodiments can incorporate the personalization data into a personalized generative remix, creating a personalized NFT artwork that can be obtained by the user. In certain embodiments, data from a user's NFT wallet could be used for the personalization, thus requiring no overt actions by the user themselves.

NFT platforms in accordance with several embodiments can generate several new NFTs from a set of source materials. NFT platforms in accordance with several embodiments can utilize generative art processes to generate unique but related variants of an artwork, which can be offered to users as separate NFTs for purchase. Described below are details for using generative remix processes in accordance with many embodiments of the invention.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

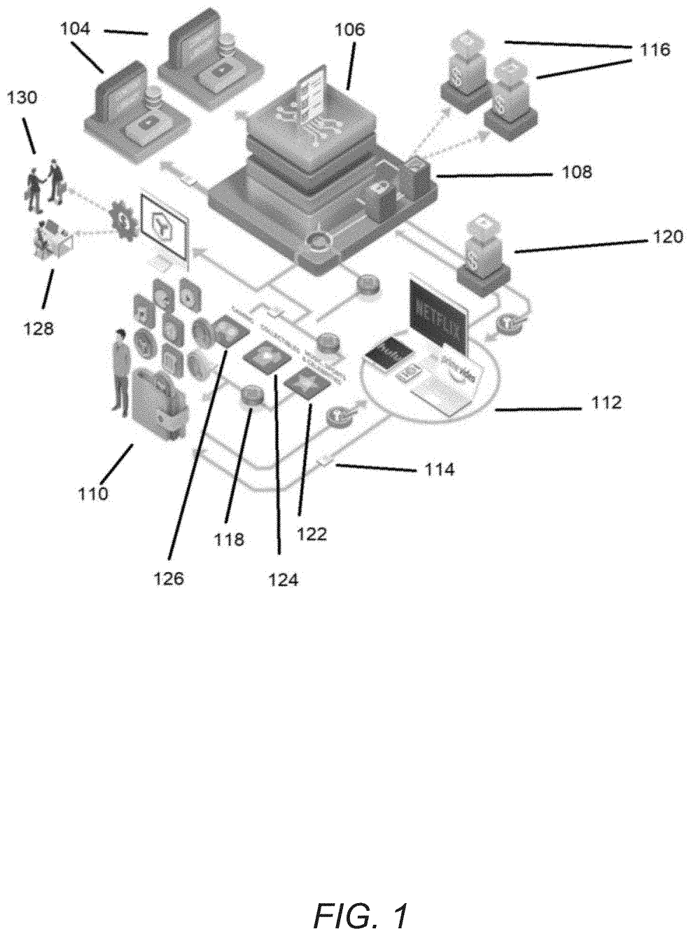

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platforms Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

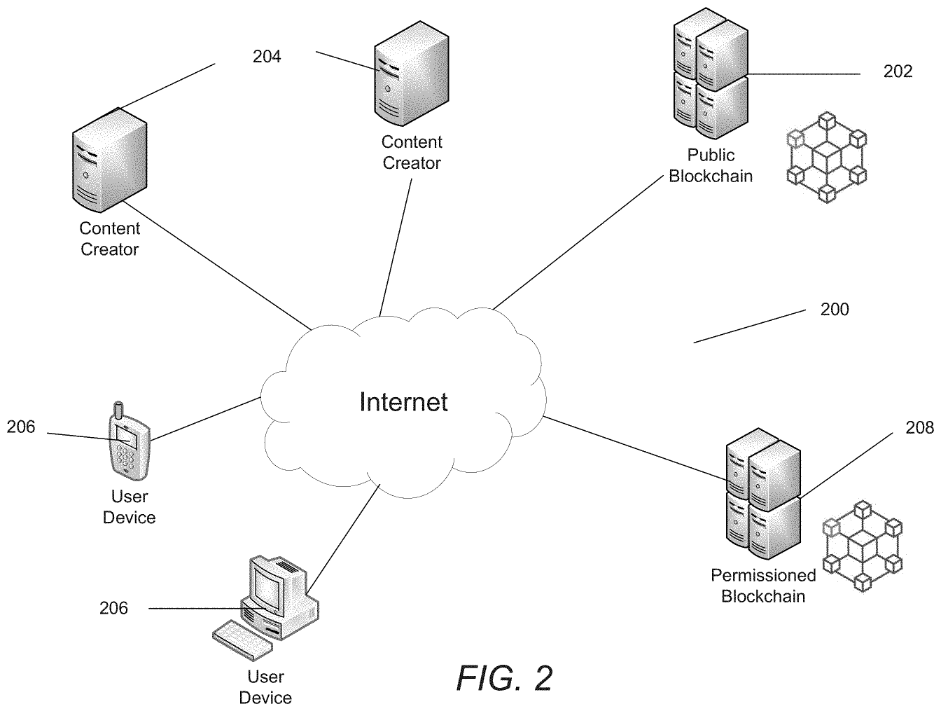

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

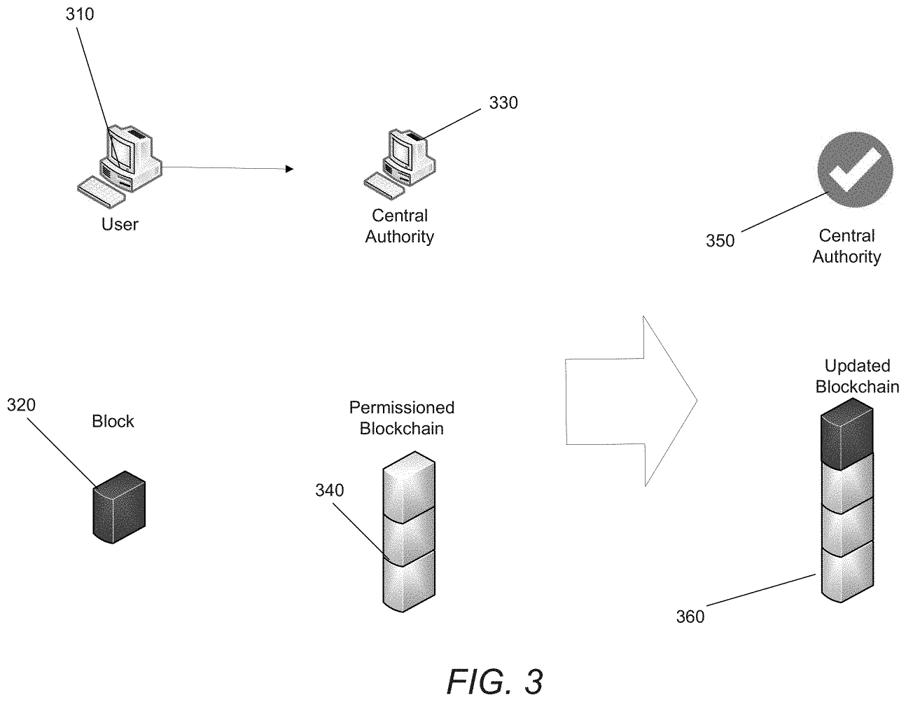

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

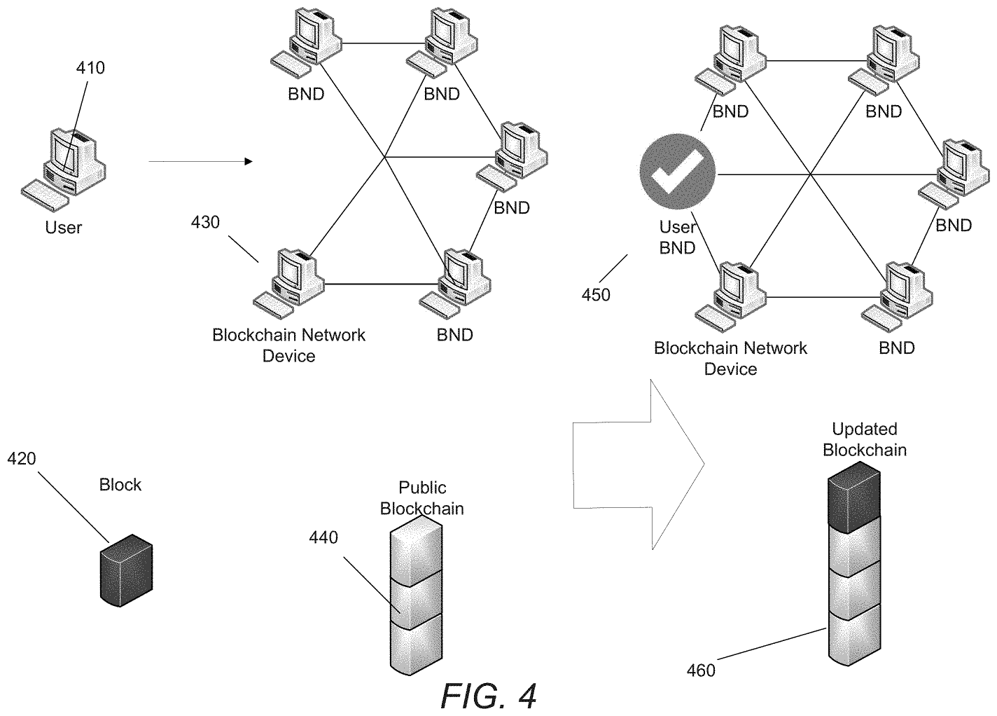

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

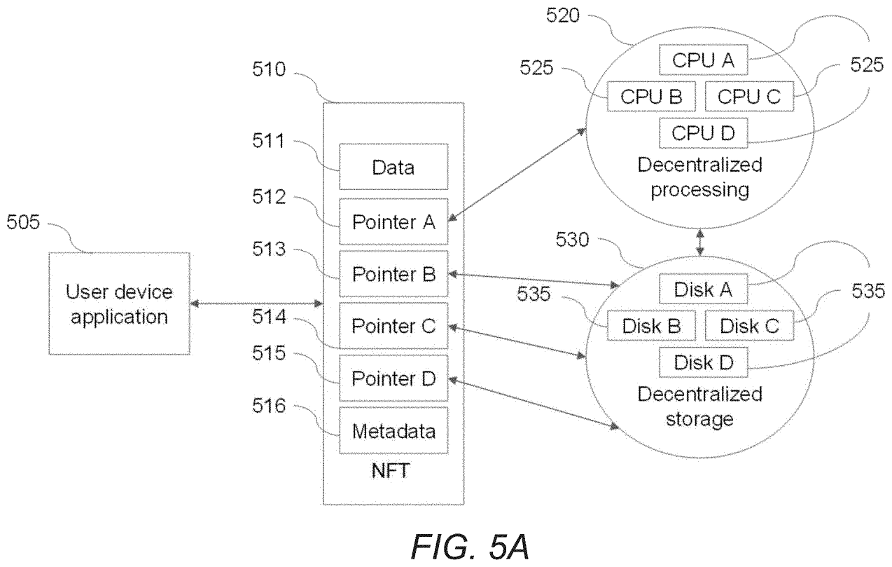

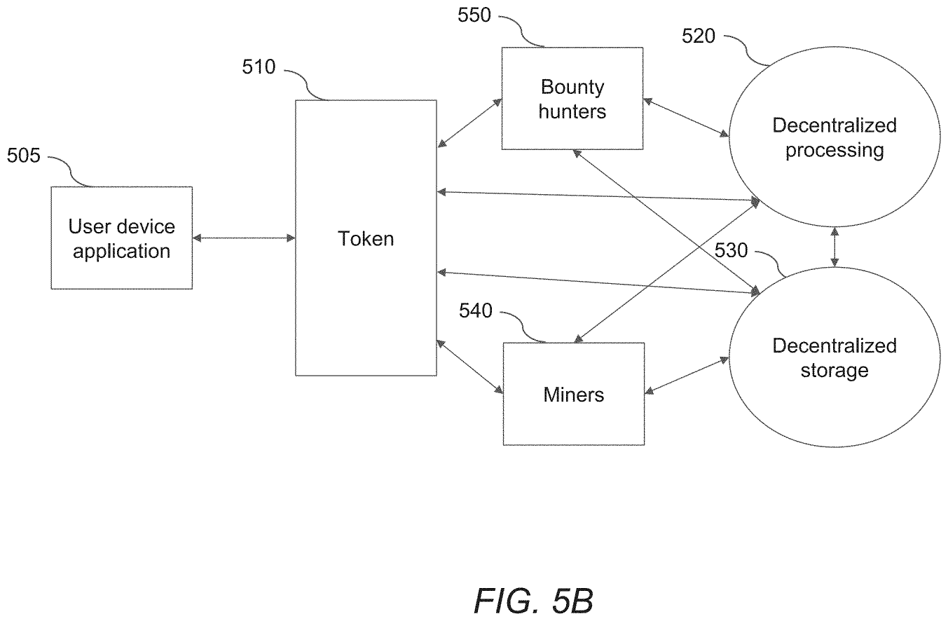

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platforms Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

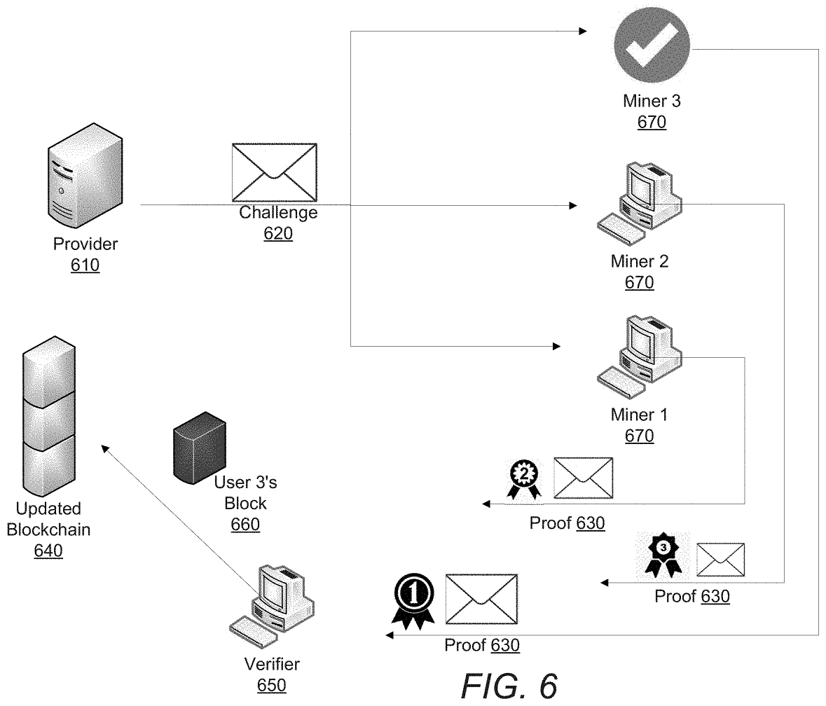

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

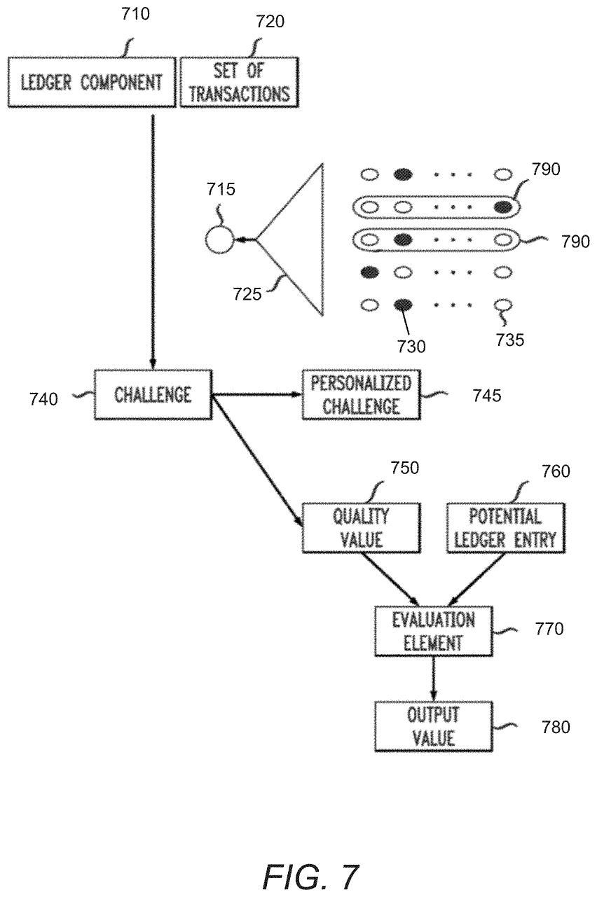

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

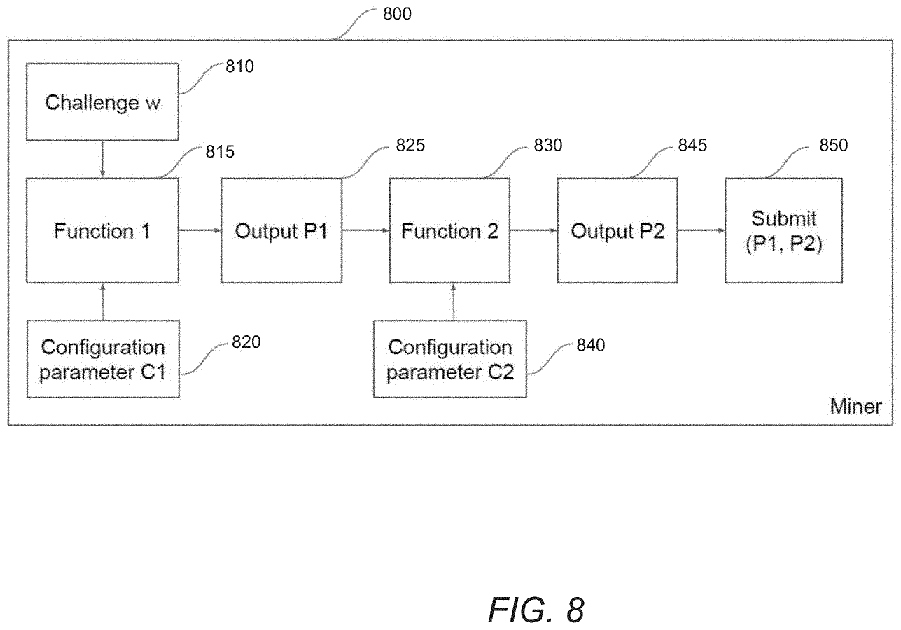

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

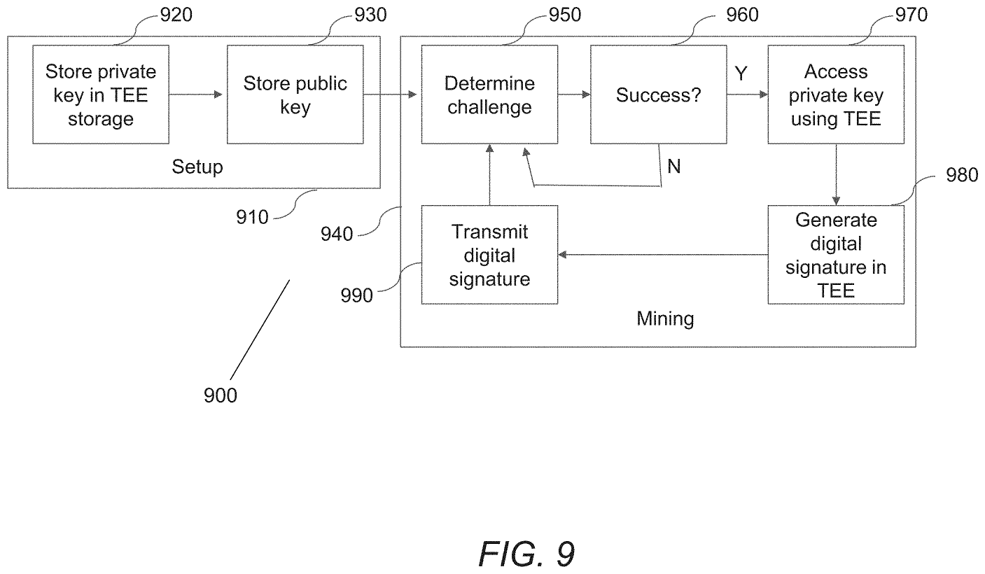

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platforms Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

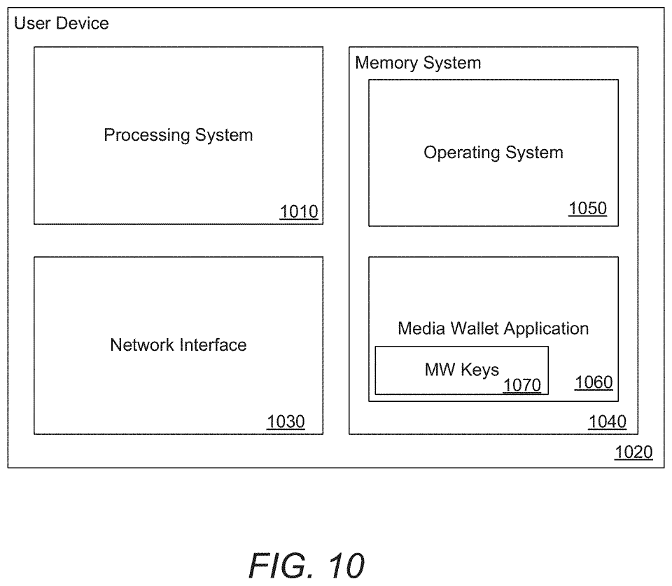

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

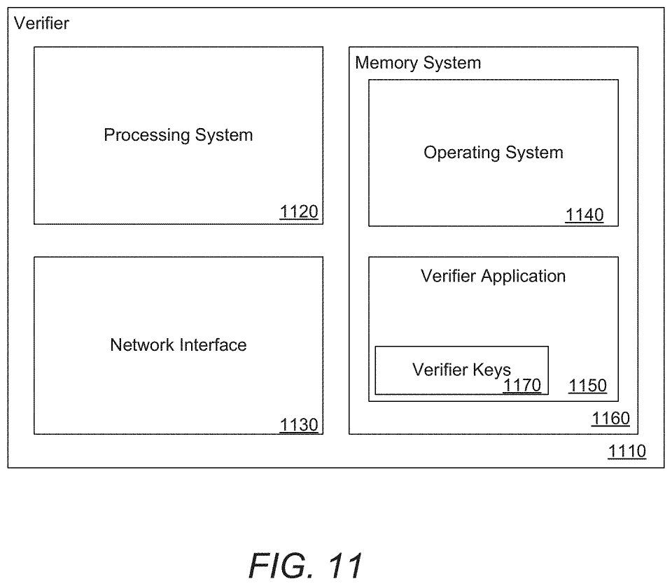

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

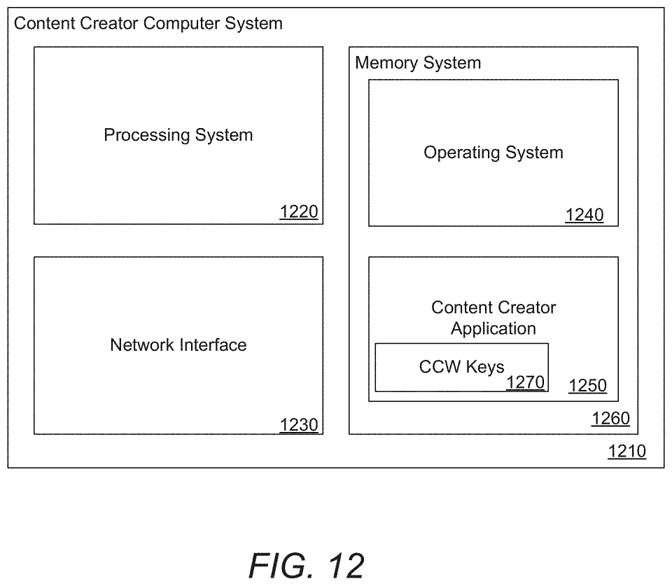

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

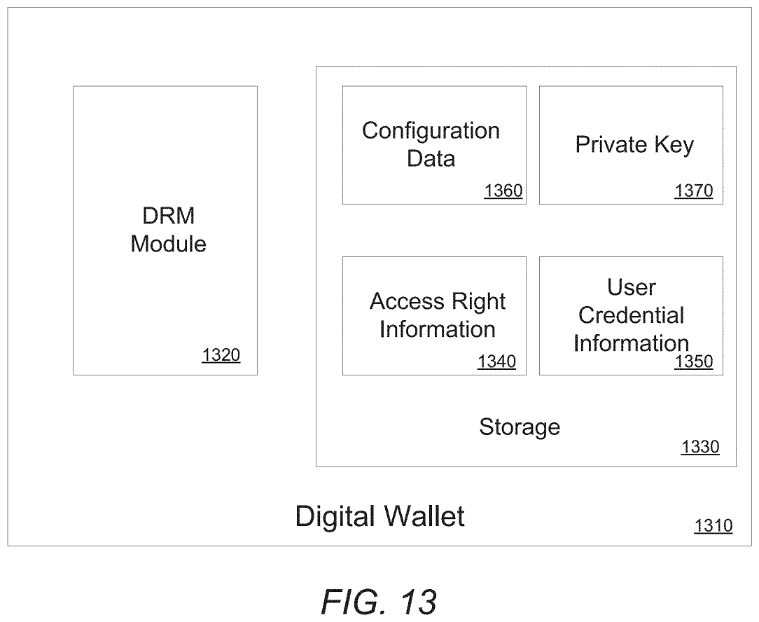

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

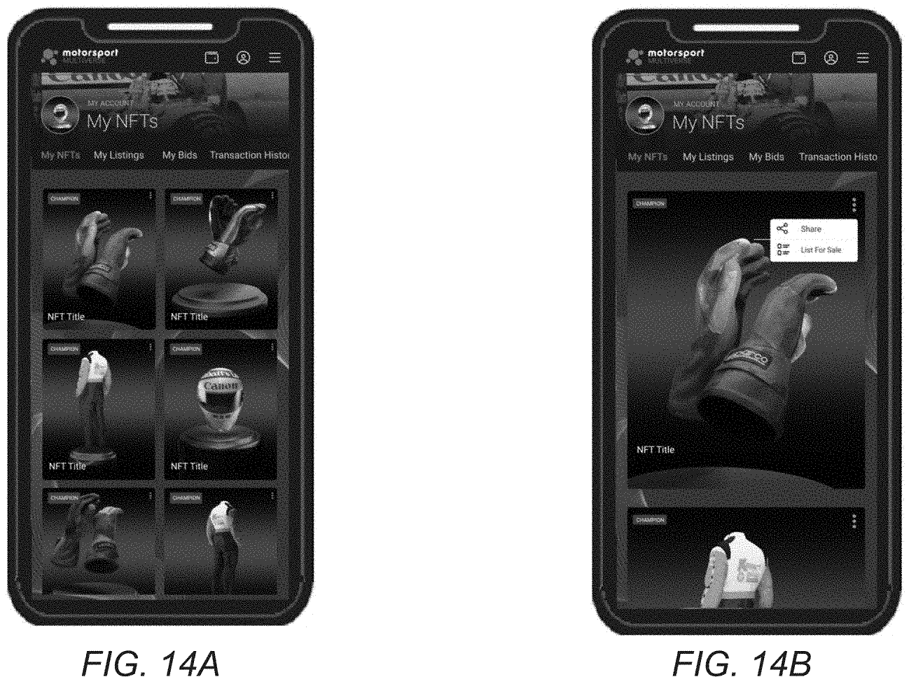

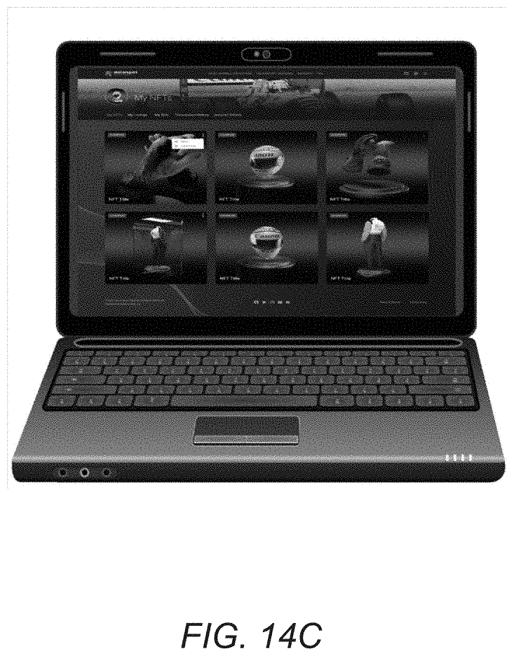

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platforms NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

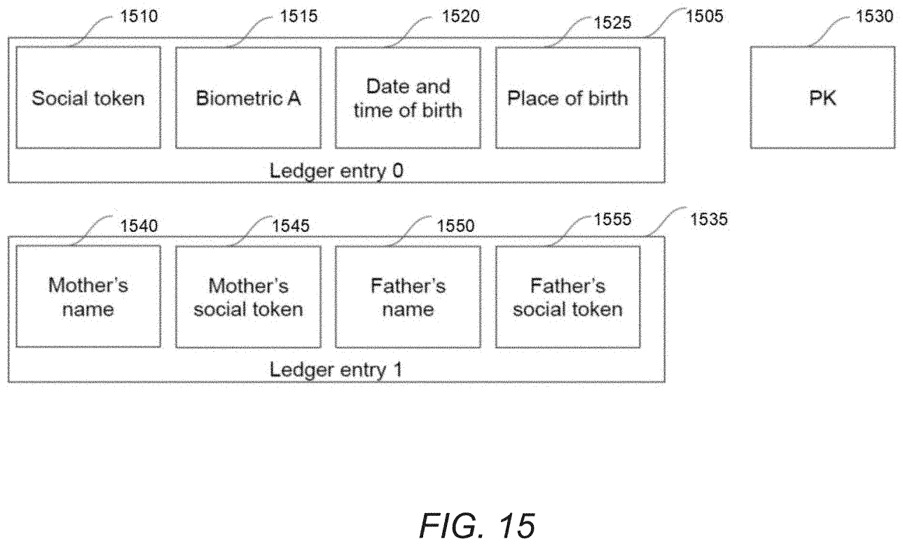

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

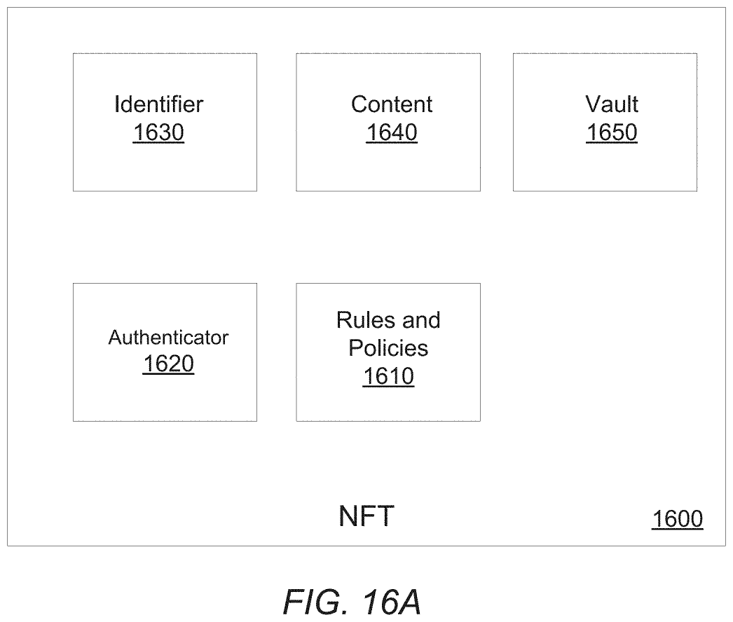

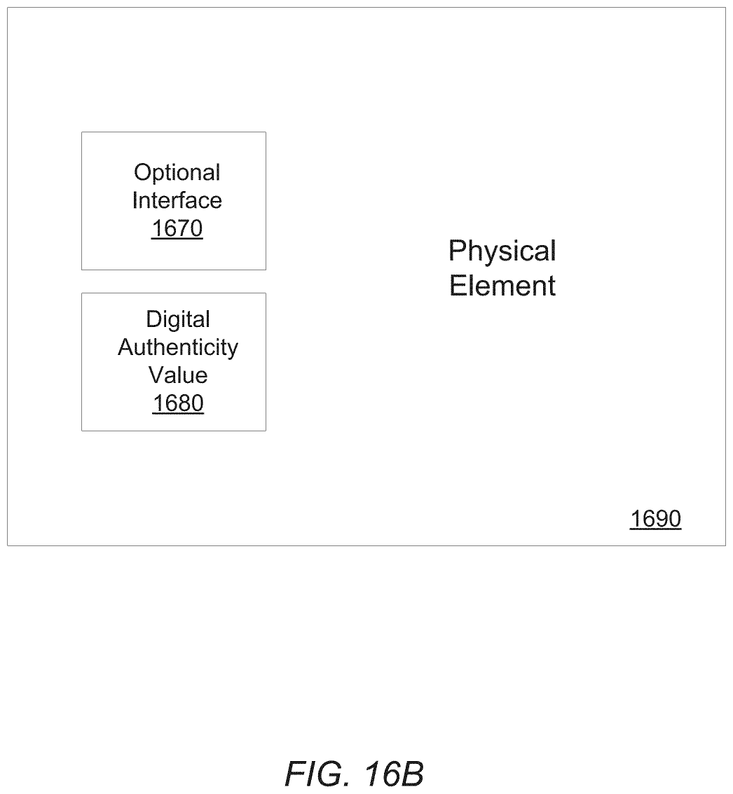

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

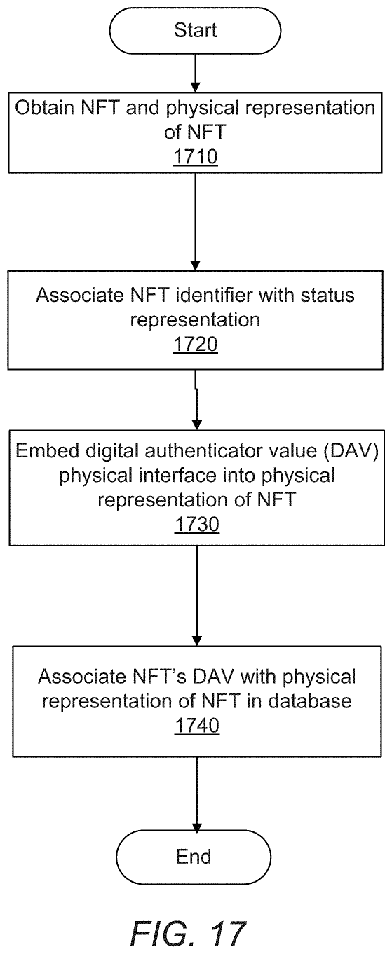

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

Robust Personalization with Applications to NFT Evolution

NFT platforms in accordance with many embodiments provide personal profile records associated with users of NFTs. In many embodiments of the NFT platforms, an anchor can be utilized that can create a connection between an input and a provider of the input. A provider of the input can correspond to an input received from a person and/or generated by a computer system. Inputs can correspond to a variety of different types of data, including personal data (e.g., birthday, birthplace, name, age, etc.) and/or non-personal data corresponding to an enterprise, a day of the week, a specified time of the year, and/or a particular stock market average, among many other types of data inputs.

NFT platforms in accordance with many embodiments can use one or more time period settings that can control different aspects of NTFs including controlling the generation of new NFTs among other types of control, which can be referred to as “throttles”. In many embodiments, a throttle can be a construct that can, for example, limit a pace and/or set a time period with which an NFT can be re-associated with a new anchor. In many embodiments, NFTs can be associated with different anchors based on an occurrence of events e.g., by being transferred from a context with a first anchor to a system with a second anchor. In may embodiments, a transfer may be legitimate and desirable but which may still in some context inhibit the performance of evaluations based on the associated anchor.

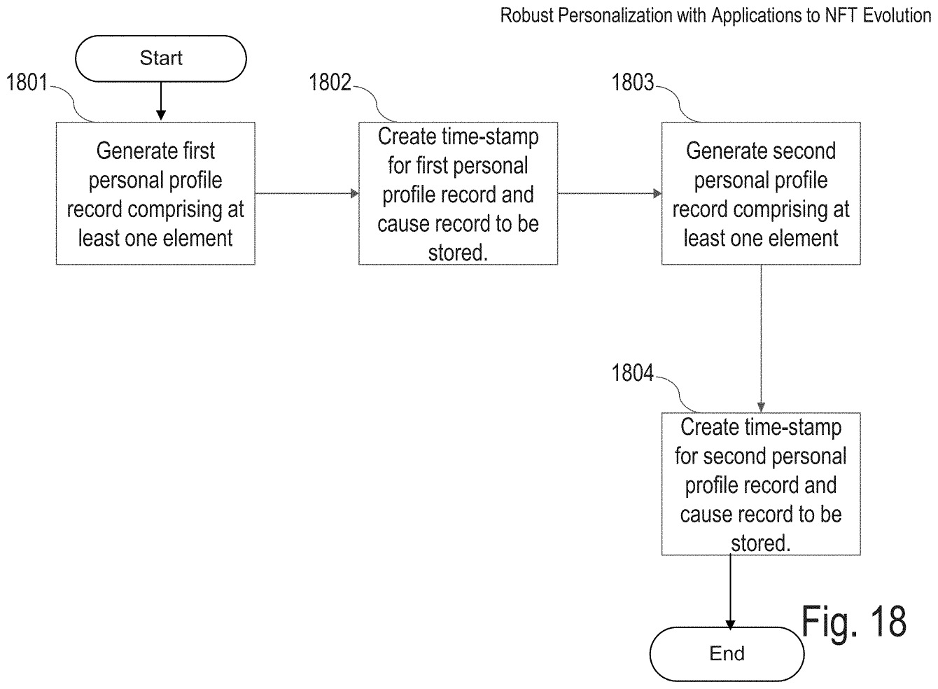

A process for generation of an anchor for a user that includes several personal profile records in accordance with an embodiment of the invention is illustrated in FIG. 18. In particular, FIG. 18 illustrates generation of an anchor for a user that includes two personal profile records. The process can generate (at 1801) a first personal profile record that can include at least one data element. The process can time-stamp and store (at 1802) the first personal profile record. In certain embodiments, a personal profile record can be stored using a blockchain. The process can generate (at 1803) a second personal profile record that can include at least on data element. In certain embodiments, this may be related to the data element of the first personal profile record, (at 1801), and/or it may be orthogonal. For example, a related data element can be an entry related to a favorite color of a user, which may be blue within the data element for the first personal profile record (at 1801), but then a value of a data element associated with color for the second personal profile record can be set (at 1803) to be red. An example of two orthogonal and/or unrelated data elements may be a data element indicating a favorite color for the first personal profile record (at 1801), and a data element indicating a birthdate for the second personal profile record (at 1803). The process can time-stamp and store (at 1804) the second personal profile record (e.g., using a blockchain). In many embodiments, a personal profile record can include an anchor that connects the personal profile record to a person and/or entity. As illustrated, the first personal profile record generated (at 1801) and the second profile record generated (at 1802) can include an anchor related to the person that they relate to. Although FIG. 18 illustrates a particular process for generating personal profile records, any of a variety of processes can be utilized as appropriate to the requirements of specific applications in accordance with embodiments of the invention.

NFT platforms in accordance with several embodiments can associate a user with an identifier, which can include an identity token, an identity certificate, an identifier associated with a private key, (e.g., as is used in Identity-Based Encryption (IBE) among others), among various other types of identifiers as appropriate to the requirements of specific applications in accordance with embodiments of the invention. In many embodiments, a personal profile records can include several data elements, and different data elements can be used for different types of data (e.g., birthday, birthplace, name, age, etc.). Using an associated private key, a signature can be created on a personal profile record that can include at least one data element. Data elements can include different types of personal profile data. For example, a first data element may be a birthday, a second data element may be a birth place, and a third data element may be a zodiac sign, among N different data elements for N types of data. In many embodiments, a personal profile record may be published, e.g., placed on a blockchain in a proprietary database, among other types of publications. A personal profile record can include an anchor. In many embodiments, a series of personal profile records can include anchors. In many embodiments, a user may add, e.g., using another and/or associated personal profile record, additional data elements at a later point in time, such as a favorite color, a lucky number, among many other types of data elements.

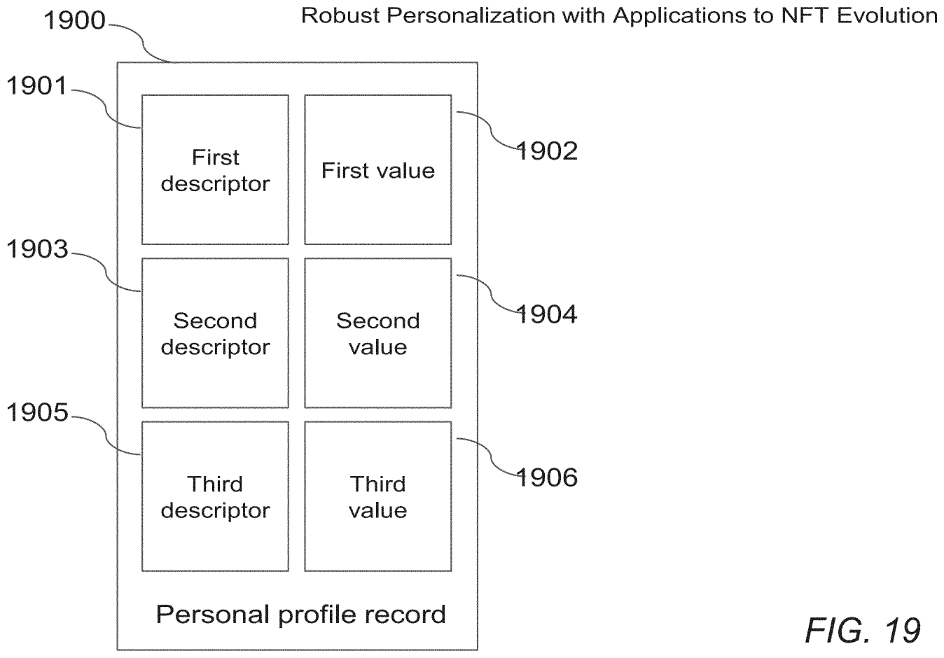

A personal profile record that includes several data elements for different types of data in accordance with an embodiment of the invention is illustrated in FIG. 19. In particular, FIG. 19 illustrates a personal profile record that includes a first descriptor data element 1901, which may be “favorite color” and an associated first value 1902 that may be “blue”; a second descriptor data element 1903, which may be “location of birth” and an associated second value 1904 that may be “Hoboken, N.J.” and/or GPS coordinates for a location; and a third descriptor data element 1905, which may be “driver's license” and an associated third value 1906 that may be the “no” or a driver's license number, expiration date, and state of issuance, and other related information. In many embodiments, a personal profile record 1900 can include 1 to N data elements (e.g., 1901, 1903, 1905, up to N), where each data element is associated with a particular type of personal date (e.g., birthday, birthplace, SSN, age, etc.) and each data element can hold a value. In many embodiments, different data elements can have different privacy settings (e.g., public, private, shared with N people, etc.). In many embodiments, different data elements can be encrypted and thus accessible only to those that have decryption access. Although FIG. 19 illustrates a particular configuration of a personal profile data record that includes certain data elements, any of a variety of configurations can be utilized as appropriate to the requirements of specific applications in accordance with embodiments of the invention.

NFT platforms in accordance with several embodiments can include personal profile records with different data elements, where certain data elements are modifiable/editable, whereby a modification can be performed by generating a new personal profile record and submitting that to a blockchain and/or database where allowed by a record policy. NFT platforms in accordance with several embodiments can include an external third-party certificate authority (CA) that can be used to assist users in creating personal profile records, e.g., by a certificate authority (CA) creating certified records, which can be stored on a blockchain and/or in the private database. In many embodiments, an anchor can be generated from one or more associated personal profile records to connect the records, e.g., by combining all the data elements of the records. In many embodiments, an anchor can be expressed as a list of properties associated with a user. NFT platforms in accordance with several embodiments can use a list of properties to perform content selections; for example, based on a birth date, a selection can be made of content that is either suitable for children or maybe not suitable for children. Similarly, a selection of one or more predictions associated with a horoscope can be made, e.g., based on a zodiac sign and a place of birth.

NFT platforms in accordance with several embodiments can use a list of properties as a personalized seed data for various different purposes of, for example, pseudo-random selections, which may be use for the determination of an action in the context of an evolution event and/or evolution timing; a peeling event (or its absence); a spawning event, and/or similar manner of configuration. Methods for evolution and peeling are disclosed in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022 which is herein incorporated by reference in its entirety.

NFT platforms in accordance with several embodiments can implement periodic control settings, which can be referred to as “throttling”, whereby for a particular set time period after the occurrence of a change, an action may disable, which can mitigate abuses related to rapid changing of different lists of properties. In particular, bad actors may perform these types of abuses in order to create more NFTs and/or higher-valued NFTs.

In several embodiments, there may be a throttling time period (e.g., one-month period, day, hours, etc.) from an association of a new set of data elements to an NFT and/or other personal profile record during which actions may be disabled on the NFT and/or personal profile record. In many embodiments, throttling may be controlled using smart contracts that record and/or identify changes and/or modifications in list of properties (e.g., set of data elements) associated with an NFT, e.g., based on time-stamped personal profile records and/or ownership records. In many embodiments, personal profile records may be accessed on at least one blockchain and/or on databases to which a smart contract has access.

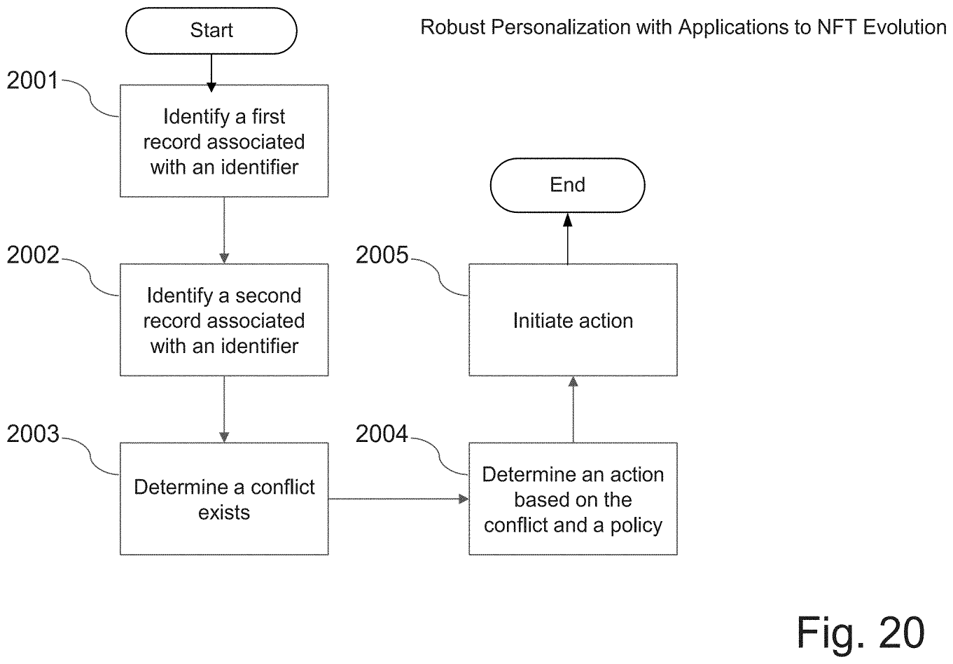

A process for determining a conflict based on a series of events in accordance with an embodiment of the invention is illustrated in FIG. 20. The process identifies (at 2001) a first personal profile record associated with an identifier. In certain embodiments, the process can scan a database for instances of the identifier. An example identifier can be a public key. The identifier may be a wallet identifier. The process can identify (at 2002) a second personal profile record associated with an identifier.

The process can determine (at 2003) that there is a conflict. In certain embodiments, the process can determine a conflict by determining that the first profile record and the second profile record include associated but conflicting records. For example, when the first personal profile includes a first personal profile record, and the second personal profile includes a second personal profile record, where the first personal profile record and the second personal profile record both have a descriptor, such as second descriptor that is the same, or where the two are related, and where the first personal profile record and the second personal profile record both have associated second value that may be part of the first personal profile record, and an associated value associated with the descriptor of the second personal profile, where the two associated values cause a conflict, e.g., based on a policy that may be specific to the descriptor value and which may be associated with it. The descriptor value “birthdate” may have a policy that the value may not ever be changed by the person being described by it, and therefore, any two associated values that are not identical would present a conflict. Another descriptor value, such as “favorite color” may have a policy associated with it that acts as a throttle and that specifies that the associated value may only change after a certain time period (e.g., once a month).

Based on timestamps associated with the first profile record and the second profile record, the process can determine whether the time between these records triggers a conflict associated with a policy. In some embodiments where data such as second value is encrypted, a determination of conflict can be performed on encrypted data, e.g., by comparing ciphertexts, and/or by finding a party with access to the decryption key to determine the associated plaintext value(s) and then determine whether there is a conflict based on these. In several embodiments, the existence of two (or more) related personal profile records can automatically be a conflict, independently of the contents of these records, and the latter of the two records in terms of their associated time stamps can be identified as the legitimate record, which can supersede a previous associated record.

The process can determine (at 2004) an action based on detecting a conflict. In several embodiments, an action may be determined based on a policy which can be associated with a descriptor. In several embodiments, policies may be stored in personal profile records, for example, in the form of executable scripts such as smart contract elements, in the form of references to rules, where the rules can be stored in a database external to the personal profile records, and/or the policies may be part of a system and code governing its functionality. In certain embodiments, an action may be to not evolve based on the data that triggered the conflict, to report the conflict to an authority, to securely log a description of the conflict, among various other types of actions. The process can initiate (at 2005) the action. The process completes. Although FIG. 20 illustrates a particular process for detecting a conflict and performing an action accordingly, any of a variety of processes can be utilized as appropriate to the requirements of specific applications in accordance with embodiments of the invention.

In many embodiments, smart contracts can include and/or be associated with configuration data associated with NFTs and govern the changes to such data, and as such, can enable control over content in a distributed manner. For example, using a smart contract as a gatekeeper. In many embodiments, an NFT platform can use a smart contract to perform throttling based on a policy associated with an NFT, and/or more generally, content associated with a request.

NFT platforms in accordance with many embodiments can include at least one centralized entity that can control an evolution of content associated with an entity. For example, a content creator may manage and/or be associated with an entity that manages a centralized entity, where the centralized entity is able to permit and/or deny an evolutionary change and/or other action, and/or provide updated material, new authentications of content, among others based on verifying that the action is permissible. For example, an entity may determine what action is to be taken based on an input that includes a list of properties associated with an owner and/or user of some content, and based on historical changes to records, historical requests for evolution, peeling, spawning and/or other controlled actions, and based on the determination, create an optional output that can be provided to a requestor, e.g., the wallet of the user who owns the NFT and/or other content tentatively to be taken an action on. A centralized entity can perform throttling based on a policy associated with an NFT, and/or more generally, content associated with the request.

In certain embodiments, individual wallets and/or other applications and/or service providers may associate an NFT with a list or properties and determine whether an action can be taken based on a policy associated with the NFT, by the wallet, and/or by a content creator associated with the content. In certain embodiments, an entity can make a local determination based on data associated with an NFT and with an owner, e.g., a list of properties associated with the owner. In many embodiments, a determination may be a generation of an action, such as an evolution event. In order to provide security against abuse, a party performing an action may need to have staked some crypto currency and/or some token, such as an NFT, with a value exceeding a threshold. Details regarding the staking of tokens such as NFTs is described in the U.S. Provisional Patent Application 63/277,472 titled “Green Proof of Stake” by Markus Jakobsson, in the context of green NFTs, which is herein incorporated by reference in its entirety; a similar approach may be used for NFTs that are not green. In many embodiments, the staking of tokens may be temporary, e.g., the staking may only be valid for 7 days after their use as guarantee for a generation of an action, after which the staked resources automatically revert to the user who staked them; however, during the time the tokens are staked, they may act as a source of funding for bounty hunters who find problems with the action. Further details on bounty hunters are disclosed U.S. patent application Ser. No. 17/808,264, titled “Systems and Methods for Token Creation and Management,” filed Jun. 22, 2022, which is herein incorporated by reference in its entirety.

In many embodiments, past ownerships of NFTs, as may be described by list of properties and identifiers of users, and/or parts of such types of information, can be used in addition to current ownerships. In many embodiments, whether an NFT can be modified may be based on information associated with a current owner and/or with a previous owner(s). For example, a type of information may be identifiers of current and past owners, where a wallet identifier and/or a public key of a user may be used as such an identifier.

In many embodiments, data elements of a personal profile record can be used to generate and/or configure an NFT. For example, zodiac signs of current and past owners can be used for the configuration of the token. In several embodiments, information can be provided to a user, such as a current owner and/or a third-party user, e.g., by looking up the ownership history of a token, such as an NFT, and then looking up a series of personal profile records associated with the current and past owners. In many embodiments, information can include personal information about a content creator. NFT platforms in accordance with several embodiments can allow a user to set privacy settings that can restrict access to different types of personal information included in different data elements e.g., by associating them with a pseudonym different from their public identifier, but which can be associated with the same and for which the association can be proven by the privacy-conscious user when desired, when a user does not want their personal information, such as list of properties, to be available to others.

In many embodiments, an NFT can be generated from at least one personal profile record. Some of information within certain data elements may be encrypted and only available to select parties (e.g., parties with decryption keys, among others), whereas certain information in other data elements may be provided in plaintext. In several embodiments, an NFT can be created from at least one personal profile record and can include various data elements including for example: E_A(id), E_B(id), pseudo, E_C(ssn), age, zodiacsign, E_D(birthplace, birthdate), preferred color, among many different types of personal profile data elements. As described in this example, id can be a value associated with an identifier, such as a public key, associated with the owner, which can be a term to indicate a person associated with the personal profile record; E_A can indicate an encryption using a key of a party A. A key may be a public key that is publicly associated with A and/or a symmetric key that may be only known to A. Party A may be a third party associated with a user of a token (e.g., consumer ombudsman representing an owner of the record.) E_B may indicate an encryption using a key of party B, where party B may be a different party from party A (e.g., party B may be a service provider contracted by an owner of the record). In certain embodiments, encrypting a same information within a same data element, id, with two keys provides that information may be accessible to two parties, namely A and B. In many embodiments, different values and/or data elements may be encrypted for one or more parties to be able to access values within the data elements. Certain information within a data element may not be encrypted, for example, a pseudonym named pseudo. Party C may know a mapping between pseudo and id. Certain personal information within a data element, such as a person's social security number (ssn), may be encrypted using a key that is associated with a distributed party C, where C may include two or more parties that may need to collaborate to decrypt the associated ciphertext.

In many embodiments, certain data elements may not be encrypted, such as an age data element and/or a zodiac sign data element. A zodiac sign of a user may be generated from a value birthdate by a party, such as party D, with access to a decryption key needed to access that information. Some values can include multiple data elements, such as the plaintext (birthplace, birthdate) which can be encrypted using a key (e.g., party D's key). Once a party (e.g., party D) decrypts a ciphertext, both the birthplace value and the birthdate value may be available to the party. In many embodiments, a party that decrypts a ciphertext can prove, in zero-knowledge, that a ciphertext corresponds to another value, such as another ciphertext, and/or a plaintext value.

For example, party D can decrypt E_D(birthplace, birthdate) to obtain (birthplace, birthdate). Party D can also prove in zero-knowledge, including non-interactive zero-knowledge, that the ciphertext E_D(birthplace, birthdate) corresponds to the value zodiacsign, without revealing the value birthplace and/or the value birthdate. In many embodiments, certain values in certain types of data elements can be modifiable, such as preferred color, whereby a user can submit a replacement value in a data element within a different personal profile record, a derived NFT, and/or by regenerating an NFT from updated input information.

In several embodiments, certain data elements may provide for specified authorities to enable modification in limited circumstances (e.g., modification of a birthdate which may not change but can still be modified by a designated authority) such as an error is detected. Certain data elements may be permanently fixed and not modifiable by any entity (e.g., “id” may be identified as a value that cannot be modified in any situation). NFTs that include personal profile records can be referenced as a personal profile NFT. Personal profile NFTs in accordance with many embodiments may include different data elements, and the above listed data elements are merely illustrative examples and not exhaustive. An NFT may include policies indicating the circumstances under which different parties may access the different types of data elements. For example, a policy associated with a data element “id” may indicate one or more service providers that may request, to either party A and/or B, to obtain a decrypted version, and what such service providers may use this information for.

NFT platforms in accordance with several embodiments can include a personal profile NFT that may include a biometric NFT and/or be associated with such a token by including a reference to it. Biometric NFTs are disclosed in U.S. patent application Ser. No. 17/808,264, titled “Systems and Methods for Token Creation and Management,” filed Jun. 22, 2022, and U.S. patent application Ser. No. 17/933,659 file Sep. 20, 2022 and entitled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” which are herein incorporated by reference in their entireties. In many embodiments, a biometric token can be used in conjunction with a biometric sensor for a user to provide proof that they corresponds to the biometric token, and, by extension, to at least one other token that has been associated with the biometric token, e.g., by the biometric token being bound to such a token.

NFT platforms in accordance with several embodiments can provide different services based on data within a personal profile NFT. For example, an application can use a biometric token and an associated personal profile NFT to determine that a user matches the biometrics in the biometric token, and that the associated personal profile NFT corresponds to a person with a right to drive a car in the state of California (e.g., the user has a valid driver license) but without disclosing certain personal information (e.g., the name and/or the age) of the associated user. A different application may use the same personal profile NFT to automate form-filling, e.g., automate the entering of a user's birthdate in forms, as well as other information. Another different application may use the same personal profile NFT to generate a personal horoscope for a user associated with the NFT. Accordingly, different applications may need different access rights to perform the different computations, where these access rights may be governed by whether the parties have the decryption keys to decrypt needed information, and/or whether they have access right tokens that indicate to third parties with the ability to decrypt information that these parties have the right to gain access to information. Access right techniques are disclosed in U.S. patent application Ser. No. 17/810,085 entitled “Distributed Ledgers with Ledger Entries Containing Redactable Payloads”, filed Jun. 30, 2022, which is incorporated by reference herein in their entireties.

NFT platforms in accordance with several embodiments can implement a throttle by determining whether several conflicting records exists, where the conflict may include a most recently stored personal profile record having an entry related to a data element also contained in a previous personal profile record, and where the two personal profile records relate to a same entity, such as a person. For example, a conflict can be if the two related entries are too close to each other in time, e.g., based on the times that the associated two records were stored. Records may be stored in a proprietary database and associated with timestamps and event data. In certain embodiments, personal profile records may be stored on a blockchain, where they can be automatically timestamped, and associated with events, e.g., other events that have been recorded on the same and/or other blockchains. When a conflict is detected, e.g., by a wallet and/or a service provider, then a remedial action may be selected. This may include, for example, ignoring at least part of one of the records; by delaying an action; by generating a complaint, e.g., by a bounty hunter; and/or by performing a filtering action, such as blocking the transmission of a message, the sale of an asset or the evolution of a token, among other actions.

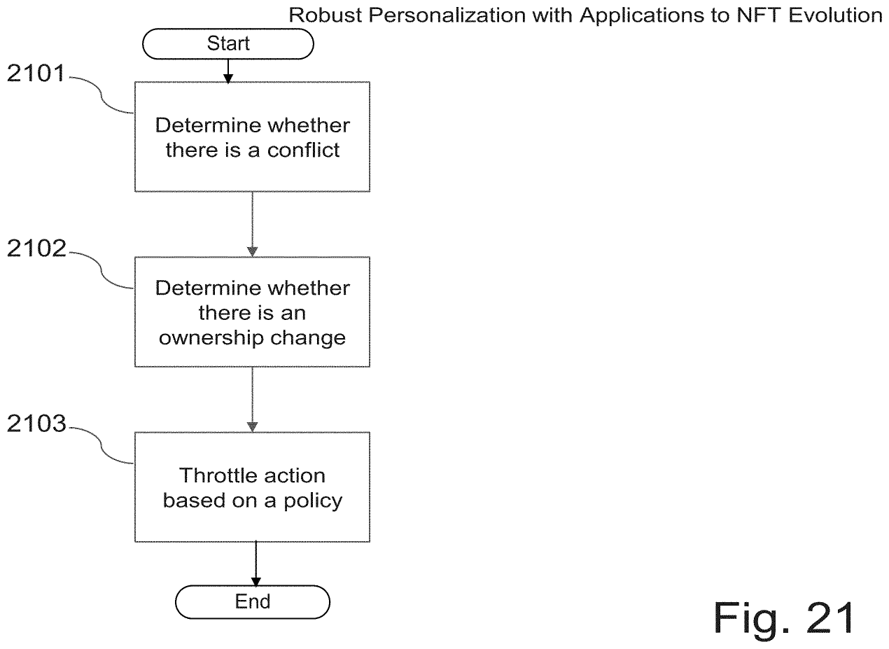

A process for throttling actions based on a detection of a conflict in accordance with an embodiment of the invention is illustrated in FIG. 21. In particular, FIG. 21 illustrates a process for the use of throttles. The process determines (at 2101) whether there is a conflict associated with an asset. In many embodiments, an asset can be an NFT whose functionality may be governed, at least in part, by an anchor that can include at least one personal profile record. The process determines (at 2102) whether the asset is associated with an ownership change, and if so, what one or more timestamps associated with ownership changes are.

The process evaluates (at 2103) a policy associated with throttling based on the conflict. In many embodiments, if a conflict detected, then the policy may be triggered. For example, if there is a change in ownership, the policy may be triggered. In many embodiments, a determination of whether a policy is triggered may depend on the nature of the conflict, as evaluated by the policy, and whether an ownership change took place within a threshold amount of time (e.g., within five days) of another event, where this other event may be another ownership change and/or an assessment of whether the policy is triggered.

The process performs (at 2103) a throttle action, based on an assessment of determining at least one policy has been triggered. In many embodiments, a throttle action may cause an event, such as an evolution event, not to take place and/or be delayed. In certain embodiments, a throttle action may cause a logging and/or an alert. In several embodiments, policies may take as inputs multiple events, for example, a series of five consecutive ownership change indications and their associated timestamps, and based on whether the policy is triggered perform an action, such as a punitive action such as destroying an NFT, limiting the functionality of an NFT, limiting access to a resource, charging a fine, invalidating at least a portion of a personal profile record, whether temporarily or permanently, among various other types of action.

NFT platforms in accordance with several embodiments can generate personal profile records for applications related to single physical persons, two or more persons/groups of people, families, enterprises, among other types of entities and a profile record can describe a group accordingly. A description of a group may include references to personal profile records and/or associated identifiers, for members of the group. Personal profile records may be generated to describe a group and/or an organization, and without describing its individual members. For example, a personal profile record may include data describing products and/or services of the organization, the types of warranties the organization offers, among other types of information.

NFT platforms in accordance with several embodiments can provide secure logging for generation of personal profile records, where an audit trail can be generated to identify an identity of a party generating and/or certifying a personal profile record, along with information identifying, in cases where a third party such as a certification authority is involved, what party and/or parties requested the certificate authority to do so. Further details on methods for secure logging are disclosed in U.S. patent application Ser. No. 17/929,988 entitled “Systems and Methods for Token Management in Social Media Environments” filed Sep. 6, 2022, which is herein incorporated by reference in its entirety.

NFT platforms in accordance with several embodiments can use at least one personal profile record as input to a consolidation service that can select data from the personal profile record and generate an NFT from the selected data. This NFT may be used in place of the at least one personal profile record, e.g., as input to another NFT and/or to a process that operates on another NFT, such as for the purposes of determining whether to perform a spawning event, a peeling event, and/or an evolution event among others. Thus, a created NFT can include personal profile record data that can be generated after it is determined whether there is a conflict, and such conflict addressed by selection of the data to be included in the NFT.

A process for throttling actions based on a detection of a conflict in accordance with an embodiment of the invention is illustrated in FIG. 21. In particular, FIG. 21 illustrates a process for the use of throttles. The process determines (at 2101) whether there is a conflict associated with an asset. In many embodiments, an asset can be an NFT whose functionality may be governed, at least in part, by an anchor that can include at least one personal profile record. The process determines (at 2102) whether the asset is associated with an ownership change, and if so, what one or more timestamps associated with ownership changes are.

The process evaluates (at 2103) a policy associated with throttling based on the conflict. In many embodiments, if a conflict detected, then the policy may be triggered. For example, if there is a change in ownership, the policy may be triggered. In many embodiments, a determination of whether a policy is triggered may depend on the nature of the conflict, as evaluated by the policy, and whether an ownership change took place within a threshold amount of time (e.g., within five days) of another event, where this other event may be another ownership change and/or an assessment of whether the policy is triggered.

The process performs (at 2103) a throttle action, based on an assessment of determining at least one policy has been triggered. In many embodiments, a throttle action may cause an event, such as an evolution event, not to take place and/or be delayed. In certain embodiments, a throttle action may cause a logging and/or an alert. In several embodiments, policies may take as inputs multiple events and trigger an action based on a policy. For example, a throttle action can take as inputs a series of five consecutive ownership change indications and their associated timestamps, and based on whether a policy is triggered, perform a action, such as a punitive action such as destroying an NFT, limiting the functionality of an NFT, limiting access to a resource, charging a fine, invalidating at least a portion of a personal profile record, whether temporarily or permanently, among various other types of actions as appropriate. Accordingly, NFT platforms can throttle actions to mitigate potential abuses that can occur with repetitive trading and/or creations of NFTs aimed at manipulating prices among other targets. NFT platforms for automatically generating remixes in accordance with many embodiments of the invention are described below.

Systems and Methods for Generating Art Remixes with Personalization

NFT platforms in accordance with many embodiments can automatically create unique NFT art and creative works, where an NFT can be personalized to a user. As background, the history of art and music abound with the reuse/appropriation of source material, “quoting” of famous works, collage techniques that combine popular and other media images, etc. From Dali's “Changes in Great Masterpieces” to Warhol and others' use of (often banal) popular imagery, the visual art world is full of examples of “remixes.” Since DJ scratching and sampling came onto the scene, the musical world is well familiar with using snips of audio to create new works. Mashups (combining two or more songs into a new one) are another example of reusing musical material to create novel but recognizable new artworks. Historically, remixes have been made by hand, by either the original artist themselves, or by other artists who use source materials from existing works by others. As such, remixes can be quite labor intensive, and may not “scale” well to a high-demand marketplace such as the Non-Fungible Token (NFT) economy.

Accordingly, NFT platforms in accordance with several embodiments can utilize automated processes for “generative remix”, whereby the NFT platform can generate several different versions from a limited set of data resources and/or from data related to an idea and/or theme. NFT platforms in accordance with several embodiments can provide on-demand NFT works (e.g., NFT artworks, music, video, imaging, among others) that can provide benefits over prior techniques that may be used by artists, such as “numbered signed prints”, as a generated NFT can be unique and/or personalized for a particular person (e.g., a person purchasing a work). In many embodiments, a set of generated NFT works may be generated that appear to a person to be from a series and/or family, however each NFT can be unique and/or personalized for an individual person.

By generating unique and/or personalized NFT works, NFT platforms in accordance with several embodiments can provide works that are unique, novel, and in-demand, which can translate to increased market value potential. In many embodiments, a generated remix can include different cuts, different instrumental emphases, different versions of vocals, among many other types of customizations that can be applied to combinations of audio, video, and visual data. Remixes can apply to non-audio content, such as photographs, where a remix may correspond to a different angle, a slightly different time of day, and/or a different set of applied modifications, among others. Thus, NFT platforms can automatically generate a remix that can apply to different set of media contexts in which there can be potential for artistic variability in the creation of multiple related content elements.

NFT platforms in accordance with several embodiments can automatically generate several different NFT work versions (e.g., different artwork versions) and thus provide a user (e.g., an artist) with increased market potential, and minimize a user's need for otherwise extra labor in creating a work (e.g. painting different paintings). NFT platforms in accordance with several embodiments can generate remixes providing work with commercial applications in the NFT space. For example, a particularly popular (or emerging) painter can use the an NFT platform to generate a series of 20, 100, or more unique but related digitally created works, filling a market demand that they may not be able to satisfy by creating such variants by hand. Accordingly, a demand of such generated variants can be higher than signed, numbered prints of a single artwork.

NFT platforms in accordance with several embodiments can allow different types of personalization, whereby individual users can contribute to automatically generated/modified NFT works, providing an engaging experience and increasing potential for marketing. For example, a user might be asked to take a photo (selfie or other), record a small snippet of their own voice, type in a text phrase, select items from a menu of preferences, and/or other forms of personalization. NFT platforms in accordance with many embodiments can incorporate the personalization data into a personalized generative remix, creating a personalized NFT artwork that can be obtained by the user. In certain embodiments, data from a user's NFT wallet could be used for personalization, thus minimizing a need for actions by a user themselves in order to personalize an NFT.

NFT platforms in accordance with several embodiments can generate several new NFTs from a set of source materials. NFT platforms in accordance with several embodiments can utilize generative processes to generate unique but related variants of a work, which can be offered to users as separate NFTs (e.g., NFTs for purchase, licensing, etc.).

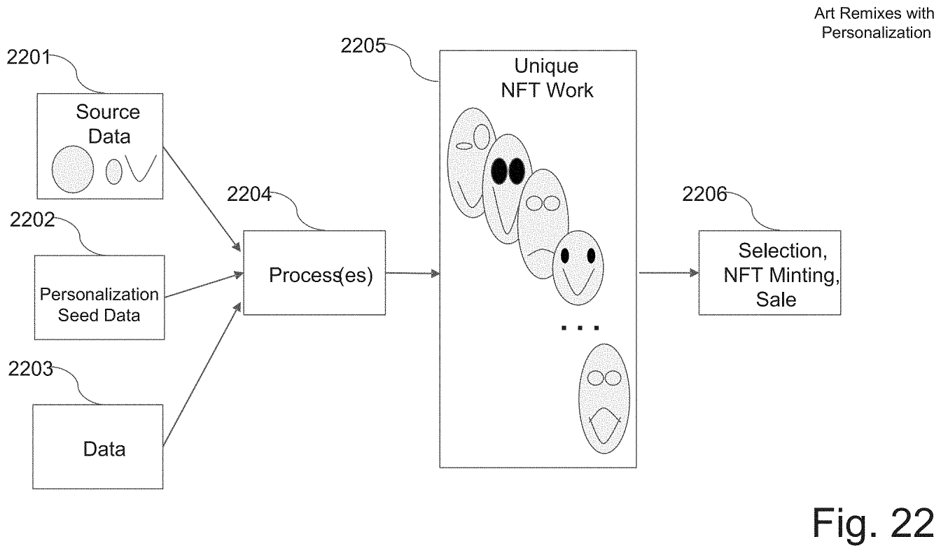

An NFT platform that generates remixes using source materials, seed data, and data in accordance with an embodiment of the invention is illustrated in FIG. 22. Source materials can be entire images, image fragments, various primitive shapes and/or curves, and/or other visual materials. Inputs to at least one generate process can include a possible personalization seed data 2202 and other data 2203. In many embodiments, the other data and/or personalization seed data can be random, unique to a user/purchaser, and/or a combination. Taking these as input, at least one process 2204 can generate at least one unique and personalized NFT 2205, which can be minted and offered/delivered for sale 2206. Although FIG. 22 illustrates a particular configuration of an NFT platform for generative remixes, any of a variety of configurations can be utilized as appropriate to the requirements of specific applications in accordance with embodiments of the invention.

NFT platforms in accordance with several embodiments can generate several similar, but discernibly different works from a source data pool (e.g., art and/or data), and a random and/or non-random seed personalization data, where a personalization seed data can be personalization data (e.g., birthday, zodiac sign, age, favorite color, among many other personalization data). In many embodiments, a work can include visual arts, audio (e.g., music), text (e.g., poetry). In many embodiments, NFT platforms can use different types of personalization seed data, where a personalization seed data can provide an ability for a user to input personal data including, among many different types of personal data such as birthdate, birth time, birth place, personalized astrological numerical information often found in Asian cultures, among others. Accordingly, NFT platforms in accordance with several embodiments can use the personalization seed data to generate customized NFTs (e.g., use numbers to derive images, sound and art based on their associated numbers and cultural representations). NFT platforms in accordance with several embodiments can obtain personalization seed data from users entering data within a wallet application, posting information to a website that serves as an oracle to a blockchain, and/or creating a personal seed data NFT, such as a derived token. Details regarding derived tokens are described in U.S. patent application Ser. No. 17/808,264, titled “Systems and Methods for Token Creation and Management,” filed Jun. 22, 2022 the entirety of which is herein incorporated by reference. Token spawning is described in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, the entirety of which is herein incorporated by reference. In many embodiments, entry of NFT seed data may be permitted several times. In certain embodiments, entry of NFT seed data can be obtained only a single time and/or as permitted by an NFT policy.

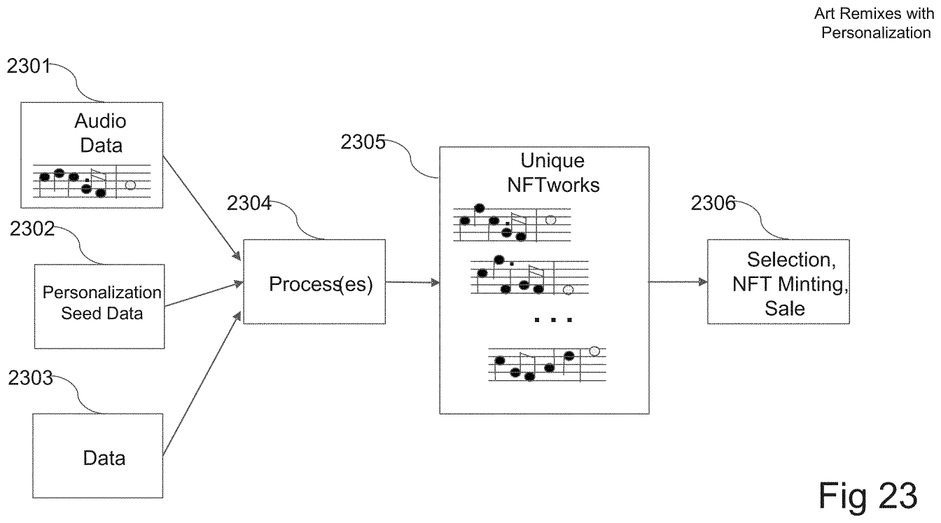

An NFT platform that generates remixes using musical source materials, personalization seed data, and other data in accordance with an embodiment of the invention is illustrated in FIG. 23. In particular, FIG. 23 illustrates an NFT platform that uses various audio musical source data 2301. The audio source data can be melodic and/or rhythmic segments of symbolic data (such as MIDI), segments of musical recordings, among other types of audio data. Other data inputs can include personalization seed data 2302 and other data 2303. The other data and/or personalization seed data can be random, unique to a user/purchaser, and/or a combination. At least one generative process 2304 can use the different types of data as input and generate at least one unique and personalized NFT 2305, which can then be minted and offered for a transaction 2306 (e.g., sale, licensing, etc.). Although FIG. 23 illustrates a particular configuration of an NFT platform for generative remixes using audio source data, any of a variety of configurations can be utilized as appropriate to the requirements of specific applications in accordance with embodiments of the invention.

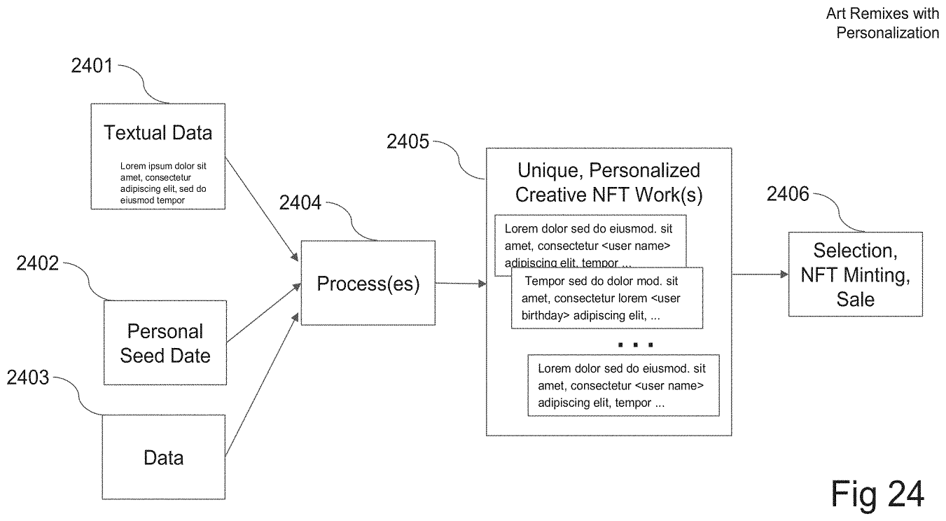

An NFT platform that generates remixes using textual source data, personalization seed data, and other data in accordance with an embodiment of the invention is illustrated in FIG. 24. In particular, FIG. 24 illustrates an NFT platform that can use various textual and/or spoken word source data 2401. Source data can include a database of text, segments of spoken word audio recordings, and/or other data. Other inputs to an NFT platform can include personalization seed data 2402 and other data 2403. In many embodiments, the other data 2403 and/or personalization seed data 2402 can be random, unique to a user/purchaser, and/or a combination. Taking these as input, at least one process 2404 can generate several unique and potentially personalized NFT works 2405, which can then be minted and offered for a transaction 2406. Although FIG. 24 illustrates a particular configuration of an NFT platform for generative remixes using text data, any of a variety of configurations can be utilized as appropriate to the requirements of specific applications in accordance with embodiments of the invention.

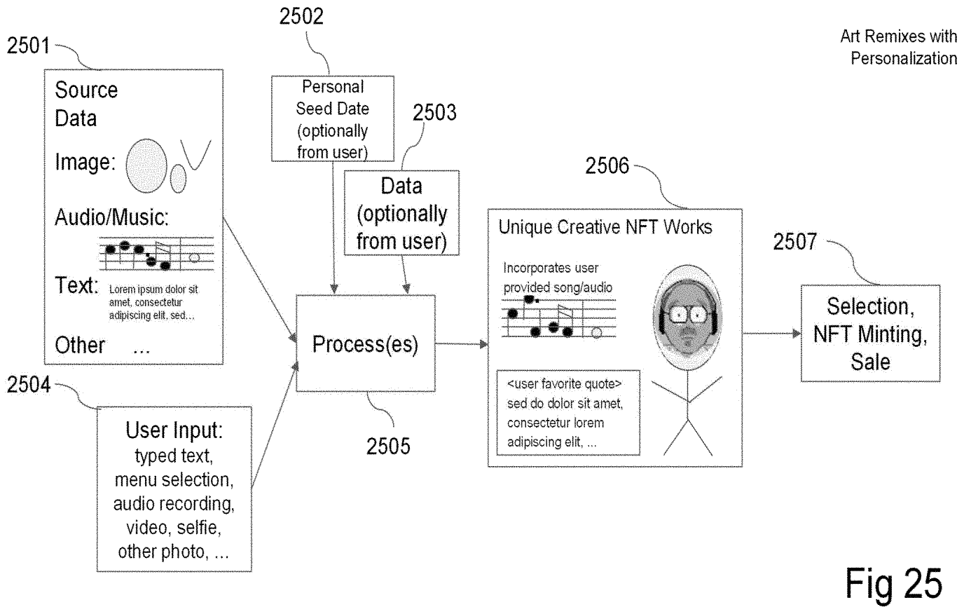

An NFT platform that generates remixes using different types of source data 2501, including a combination of images, video, audio, and/or text data, personalization seed data, and other data in accordance with an embodiment of the invention is illustrated in FIG. 25. In particular, FIG. 25 illustrates an NFT platform that can use a set of source data 2501, such as image data, video data, audio data, and/or text data. The NFT platform can receive personalization seed data 2502 and other data 2503 as inputs. In certain embodiments, the inputs can be provided by a user and/or collected from a user's wallet and/or other information store. In many embodiments, a user can explicitly provide personalization seed data 2502 in the form of typed text, one or more selections from a menu, a voice recording, photo, video (e.g., from a smart phone and/or watch), and/or other media. At least one process 2505 can use the different types of data from the different data sources to generate at least one personalized NFT work 2506, which can then then be minted and offered for a transaction (e.g., sale, license, etc.) as NFTs 2507. Although FIG. 25 illustrates a particular configuration of an NFT platform for generative remixes using image, audio, and/or textual materials, any of a variety of configurations can be utilized as appropriate to the requirements of specific applications in accordance with embodiments of the invention.

NFT platforms in accordance with several embodiments can personalize NFT work for individual users, which can increase value for NFTs. For example, personalization seed data can be collected from a variety of different sources, including a user's NFT wallet, social media, and/or other external source, and/or data can be explicitly provided by a user such (e.g., as a voice recording, digital photo, typed-in text, and/or selections from a series of menus). NFT platforms in accordance with several embodiments can use a user's personalization seed data as input to generative remix process(es) which can generate personalized NFT works. For example, a user can record themselves speaking (e.g., say their name or any other utterance) on a mobile device, and the audio data can be used by at least one automatic generative remix process, which can utilize the audio date (e.g., “folded”) with other types of source data (e.g., video, audio, images, such as source materials for a musical and/or poetic remix), where the source data may be obtained from an original source data (e.g., original audio, original video data, originail image data) and the user's personalized seed data (e.g., sound recording) can be incorporated into a final NFT artwork, providing a unique NFT.

NFT platforms in accordance with several embodiments can include generative remix processes that can generate unique NFT works from a common source data. Audio examples of a common source base can be musical motifs, and/or sound files of sonic source materials. Visual data examples of a source base can be a palette of shapes and colors, photographs and/or other still images, video clips, among other types of video data. Examples of textual source data can include a corpus of text (e.g., lyrics of songs from a particular artist), and/or words, among others.

NFT platforms in accordance with several embodiments can generate NFTs based on a random and/or specific type of deterministic personalization seed data, where an NFT work generated from a source data can be perceptually different, yet related due to the use of common source data. Examples of works based on such resources could include a family of generated audio musical remixes of a common base audio “song,” varying by style or genre (e.g., pop, K-Pop, J-Pop, rap, among others) and/or instrumentation (e.g., acoustic bass, electric bass, synthetic bass, among others), or musical structure (e.g., ABACA vs. ABCAB, etc., where A=Verse, B=Chorus, C=Bridge).

NFT platforms in accordance with several embodiments can generate NFT works that are personalized and/or unique using automated processes and minimize a need for additional user data, thus avoiding a need for manual modifications of source data such as audio, images, videos text, among others to generate a remix. NFT platforms in accordance with several embodiments can use fractal processes and/or cellular automata, which can recursively operate on state variables, often stored as a minimal seed of data and can be used to generate patterns from previous patterns. NFT platforms in accordance with several embodiments can use these processes along with NFT minting and user personalization to generate NFT works on demand.

NFT platforms in accordance with several embodiments can generate NFTs directly from program code. For example, an NFT of a visual work including images and video can be generated by code written in an environment such as Processing and/or OpenFrameworks, and music and sound work can be generated by code written in environments such as ChucK, SuperCollider and/or Max/MSP™. Such programs may incorporate additional source materials such as images, videos, music, text, and/or others, and/or they may generate new images and/or audio from scratch using procedural means. For an illustrative musical example, a fractal melody generator could draw from a short list of musical notes, generating potentially thousands of melodies, all essentially in the same “key,” but different based on a seed and/or other data provided by a user (either explicitly and/or drawn from their behavior or data). As another musical example, a drum rhythm generator could encode the probability of each of a snare, hi-hat, and/or bass drum playing on each subdivision of a beat, and the seeds used to sample from these probability distributions could be set by data provided explicitly by the user and/or captured from user behavior and/or input. For example, in a visual work, variations of a size, position, color, lighting, and other properties of shapes procedurally drawn in a scene could be varied according to one or more personalization seeds whose values can be set from user inputs and/or behaviors. NFT platforms in accordance with several embodiments can generate personalized NFT works by allowing one or more behaviors be driven by a value of at least one seed value derived from and/or input by a user.

NFT platforms in accordance with several embodiments can personalize a generated NFT using personalization seed data that can be unique to each user and/or source data that can be added that is unique to a user. Personalization seed data can include data about a user such as birthdate, userID number, taste preferences, among many other types of personal data, which can be mined from a user's crypto-wallet among various other internal and/or external sources of data. In certain embodiments, a user can select one or more categories and/or rankings from a menu or other user interface, which can be combined with a pseudo-random seed to create a unique NFT artwork.

NFT platforms in accordance with several embodiments can use text data typed in by a user, which can be used as source data for generating a unique, personalized NFT artwork. In certain embodiments, personalized seed data can be incorporated from recognizable aspects about a user, such as a photo of their face, their pet, their car, among other types of data. A personalized NFT work may incorporate audio data obtained from a recording of a user's actual voice (e.g., a user saying their name, singing a short phrase, among others). NFT platforms in accordance with many embodiments can incorporate personal seed data content in an NFT work in a recognizable way, for instance a user's short recorded phrase could appear in an NFT work itself. In certain embodiments, a type of content can determine a generated NFT work through determining and/or contributing to a setting of a seed value.

NFT platforms in accordance with several embodiments can generate personalized NFTs using machine learning processes, which can incorporate user content into the generated NFT works. For example, “deep fake” image processes can be used to replace a face in an image with the face of a user, and/or audio “deep fake” processes could be used to render a text segment provided by the user in the voice of a musician or likewise to re-render a creator's sung and/or spoken text in the voice of the user. NFT platforms in accordance with several embodiments can utilize techniques such as CycleGAN and/or Style Transfer to apply a visual style of an artist, defined by a single new artwork and/or a combination of artworks, to a new image uploaded by a user.

NFT platforms in accordance with several embodiments can use machine learning processes to provide user control over generated NFT works. For example, a user interface for custom artwork generation might enable users to manipulate the location or trajectory through latent space of a generator, for instance providing a slider for adjusting the presence and degree of a smile on a person in a still image, or changing this over time in a video. Or, for example, a user interface could provide a drop-down menu for a user to select the desired mood and/or style of a musical segment. This could influence a choice and parameterization of a generative process as utilized by an NFT platform in accordance with an embodiment, for example using a melody generator transformer that has been trained and/or fine tuned to generate “sadder” and/or “jazzier” melodies. Or, for example, it could be used to filter the outputs of a melody transformer to select the one that is the “saddest” or “jazziest,” using one or more logistic regression models trained to recognize such concepts of interest.

NFT platforms in accordance with several embodiments can generate NFTs of text (e.g., poetry) which can be created from a source of text data and/or audio data recordings. In many embodiments, the NFTs of text (e.g., poetry) can be personalized as described herein. In many embodiments, varying degrees of lexical analysis can be performed on an original source material, identifying nouns, verbs, and other parts of speech, as well as identifying characteristics such as rhyming and stress patterns, to aid in creating more compelling final unique works of (computer) creative writing. Items from a user/purchaser's personal correspondences, wallet contents, and/or other sources of personal data can be incorporated into the generative process, yielding a unique and personal “poem” or story.

NFT platforms in accordance with several embodiments can use generative remix processes to generate sets of related artworks. Further details on managing NFT sets is disclosed in U.S. Provisional Patent Application 63/311,322 titled “Methods for Assigning and Maintaining NFT Relationships” filed Feb. 17, 2022, the disclosure of which is herein incorporated by reference in its entirety.

NFT platforms in accordance with several embodiments can generate remixes that can remix based on a transaction (e.g., resale). For example, an artwork might itself change when ownership changes. In many embodiments, an NFT can reflect new characteristics based on an occurrence of an event and/or transaction associated with the NFT. For example, a purchase-changed artwork may reflect new characteristics related to a new owner, and optionally could still reflect aspects of previous owner(s). An example of this might be a collage-type visual artwork where new image fragments are added and overlaid each time a new owner purchases the work.

NFT platforms in accordance with several embodiments can provider users with different types of rewards (e.g., providing users with multiple NFTs that represent a work based on transactions, such as a user purchasing multiple NFTs from a set). For example, a collector might buy a generative remix with a jazz backing, as well as a remix with a hip hop beat of the same collection. A third token can be generated that combines both of them and has a jazz and hip-hop backing airdropped as a reward to that collector.

Another example: a collector buys a generative remix that resembles a frog and a generative remix that resembles a bird from the same artist. As a reward the system can generate a new work that is a cross between a frog and a bird and airdrops that to the collector as a reward.

In many embodiments, an NFT platform can generate multiple new NFT works from at least two initial NFTs, and these could be represented as multiple NFTs and/or as a single NFT. An NFT can include for example a video that includes a sequence of images assembled into sequential frames. For example, when an initial artwork has been generated using machine learning techniques such as GANs, and/or when they can be represented or approximated as points in a latent space of a generative model, a sequence of multiple new artworks can be generated by interpolating from one initial artwork's point in the latent space to another initial artwork's point in this space.

For example, for a bird-frog example described above, a sequence of stills could be generated showing the bird morphing into the frog, and these could each be minted into an NFT and/or they could be assembled into a single NFT that includes a video showing the morphing process. This kind of morphing can be used to achieve many other effects, for example to give the impression of traveling through a virtual landscape, viewing a virtual object from different angles, watching a person's face age, and/or listening to a musical melody and/or rhythm transform over time, etc.

For example, using similar processes, an artist can have a sponsor involved bringing their brand into the remix. For example, a visual artist might have a Coca-Cola sponsor, and an NFT platform can generate a piece of artwork using their brand using the StyleGAN machine learning trained on works of the artist.

In many embodiments, an NFT platform can generate new NFTs and can award these NFTs of a work to particular users (e.g., collectors) as they accomplish various tasks (e.g., such as owning multiple versions of a collection, etc.). In many embodiments, NFTs can be used at a sponsors' websites as coupons, or even as VIP access to corporate events or social groups they put together. NFT platforms in accordance with many embodiments can apply similar processes to different types of NFTs such as audio source data. For example, in the case where a melodic content of a certain advertising song (“jingle”) is augmented with harmony and rhythm derived from generative machine learning models such as hidden Markov models, recursive neural networks, and/or transformers trained on the harmony and rhythm of the musician.

For example, a new melody can be created using generative processes, trained on melodies of the musician, by beginning with the melody of the jingle and continuing it in the style of that musician.

For example, new song lyrics can be generated using text generation models trained and/or fine-tuned on text about a product or brand, potentially augmented with lyrics that have been previously manually written and/or with model fine-tuning on other lyrics by the musician, and a generative music or singing model such as a transformer trained on data from the musician could be used to generate a new song, sung in the style of the musician and sounding as if they were singing the newly generated lyrics.

For example, Bill is a country singer working with a car-maker sponsor who would like to promote a new model of truck. Bill writes a short song about trucks, with a catchy chorus that is written in its entirety but with verses that will be filled in later, and he records the instrumental and vocal parts for the song, excluding the verse vocals, in the studio. A pre-trained language transformer can then be fine-tuned on a corpus containing both text about the new truck model and lyrics from Bill's other songs and his chorus for this song. A “vocal deepfake” voice synthesis model can also be trained on examples of Bill's singing recorded in the studio. To generate new versions of the song the following process can be applied: The text generation transformer produces text lyrics for the new verses, guided by computational models of English rhyming and prosody to maintain suitable alignment to the music. A deepfake synthesis model can render these lyrics in the style of Bill's singing voice and they are inserted into the recorded song. Each such version of the song can be released as a token.

NFT platforms in accordance with several embodiments can use genetic algorithms, fractal and/other recursive algorithms, deep learning and/or deep fake, and/or other machine learning (ML) and/or Music Information Retrieval (MIR) analysis/resynthesis processes, among others.

NFT platforms in accordance with several embodiments can personalize a set of NFTs (e.g., personalize a gallery of art or collage of art) based on the data obtained from a user's wallet (e.g., items purchased in a user's wallet). This can allow users to curate a work they like from their collection, selecting items from their wallet to be incorporated into a 2D or 3D gallery or collage of images, video and audio that is unique and personalized to that user. In many embodiments, combination of NFTs can be used to generate new NFTs. Many embodiments can generate a smart contract that complies with aspects of other smart contracts, including dividing royalties and/or other financial elements based on the number of NFTs combined to create a new unified collage.

NFT platforms in accordance with several embodiments can generate and/or configure content to be used for multiple NFTs that can be made available independently of each other, e.g., a first NFT can be sold to a first user and a second NFT to a second user that may be the same and/or different as the first user. In certain embodiments, a first NFT can be an evolutionary NFT that, when an evolutionary trigger is observed, causes a change that turns the first NFT into a second NFT, and/or where the content of the second NFT can be added to the first NFT. The latter can be achieved, for example, by letting the second NFT be a derived NFT that enables access to content of the first NFT, but also to content that is referenced by or carried by the second NFT. Further details on derived tokens are disclosed in U.S. patent application Ser. No. 17/808,264, titled “Systems and Methods for Token Creation and Management,” filed Jun. 22, 2022 and details of token evolution is disclosed in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, the entireties of which are hereby incorporated by reference.

NFT platforms in accordance with several embodiments can use several different selector values to generate several related versions of a same NFT work (e.g., an NFT visual art piece, such as a painting; an NFT audio art piece such as a recording of a song; and/or an NFT audio-visual art piece where there are both audio and visual elements that are configured).

For example: one selector value could cause a music video to be generated with the drums (and/or scenes of the drummer) emphasized. A different selector value could cause a music video to be generated with the lead guitar images and/or audio highlighted. Another selector value could cause a particular still image to be generated and minted as an NFT.

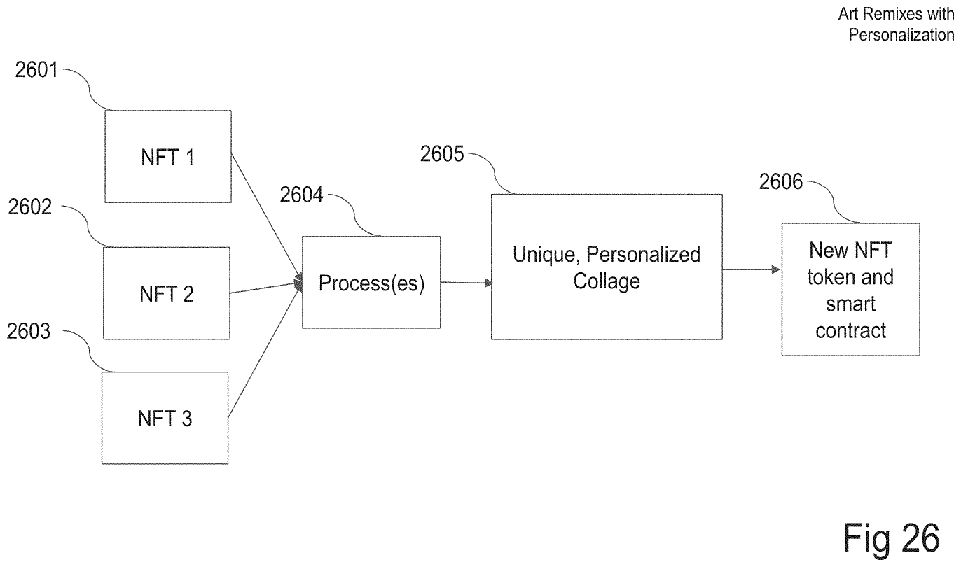

An NFT platform that generates new NFTs using several NFTs in accordance with an embodiment of the invention is illustrated in FIG. 26. In particular, FIG. 26 illustrates an NFT platform that can obtain a select set of NFTs (e.g., NFT 1, NFT 2, NFT 3) from a particular source (e.g., a user's wallet), and process the NFTs using at least one process 2604. In many embodiments, a process can identify similar properties across different NFTs (e.g., color, form and/or shapes) using machine learning processes which can then be used to auto generate 2605 an NFT collage representing a collection of different set of NFTs (e.g., all 3 of the NFTs) combined together. In many embodiments, an NFT platform can allow a user to approve and/or modify a resulting NFT collage. In many embodiments, the NFT platform can allow a user to choose to mint an NFT collage 2606 in a new smart contract and/or a new NFT. In many embodiments, a generated smart contract can comply to rules and regulations of the terms set in other smart contracts associated with other NFTs (e.g., smart contracts in each of NFT1 2601, NFT 2 2602 and NFT 3 2603). Although FIG. 26 illustrates a particular configuration of an NFT platform for generative NFT collages using sets of other NFTs, any of a variety of configurations can be utilized as appropriate to the requirements of specific applications in accordance with embodiments of the invention.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A non-fungible token (NFT) platform for processing tokens in a distributed computing environment, comprising:
a network interface;
memory; and
at least one processor executing on at least one computing unit from a plurality of computing units in a distributed computing environment, wherein a processor is configured to:
maintain a database of a plurality of personal profile records, wherein each personal profile record is associated with a particular entity and comprises a plurality of data elements associated with different types of data for the particular entity;
obtain a first personal profile record associated with a first entity;
obtain a second personal profile record associated with a second entity;
determine that the first entity and the second entity are a same entity;
detect a conflict between a data element associated with the first personal profile record and a data element associated with the second personal profile record, where the data element associated with the first personal profile record and the data element associated with the second personal profile record comprise a same type of data and detecting a conflict comprises analyzing a smart contract associated with at least one of the first personal profile record and the second personal profile record;
initiate an action based on the smart contract associated with the at least one of the first personal profile record and the second personal profile record.

2. The NFT platform of claim 1 wherein the first entity is an individual.

3. The NFT platform of claim 1 wherein the first entity is a group of individuals.

4. The NFT platform of claim 1 wherein the first entity is an enterprise.

5. The NFT platform of claim 1 wherein the first personal profile record comprises a digital signature that is verified using a public key associated with the first entity.

6. The NFT platform of claim 1 wherein the first personal profile record comprises a digital signature that is verified using a public key associated with a certification authority.

7. The NFT platform of claim 1 wherein the smart contract associated with a first descriptor, the first descriptor comprised in the first personal profile record.

8. The NFT platform of claim 7 wherein the conflict is determined based on a first value associated with the first descriptor.

9. The NFT platform of claim 1 wherein data associated with the smart contract is stored in the first personal profile record.

10. The NFT platform of claim 1 wherein data associated with the smart contract is public.

11. The NFT platform of claim 1 wherein the action is at least one of allowing and disallowing an event taking place and generating a secure log entry.

12. The NFT platform of claim 11 wherein the secure log entry comprises encrypted information.

13. The NFT platform of claim 11 wherein the secure log entry comprises authenticated information.

14. The NFT platform of claim 13 wherein the authenticated information is generated using a forward-secure authentication scheme.

15. The NFT platform of claim 1 wherein the determined action comprises generating a non-fungible token (NFT) based at least in part on the first personal profile record or the second personal profile record.

16. A system for automatically generating at least two non-fungible tokens (NFTs) based on at least one content element, comprising:
obtaining the at least one content;
determining a first selector value;
determining a second selector value that is distinct from the first selector value;
generating a first content element from the at least one content element and the first selector value;
generating a second content element from the at least one content element and the second selector value, wherein the second content element is distinct from the first content element;
generating a first NFT associated with the first content element; and
generating a second NFT associated with the second content element.

17. The system of claim 16 wherein at least one content element is one or more still images.

18. The system of claim 16 wherein at least one content element is one or more video media.

19. The system of claim 16 where in at least one content element is one or more MIDI or other musical score files.

20. The system of claim 16 wherein at least one content element is one or more music or audio recordings.
